(19) United States
(12) Patent Application Publication
(10) Pub. No.: US 2025/0102951 A1
(43) Pub. Date: Mar. 27, 2025

(54) IMAGE FORMING APPARATUS

(71) Applicant: FUJIFILM Business Innovation Corp., Tokyo (JP)

(72) Inventors: Kazuya UMEKUBO, Kanagawa (JP); Atsushi FUNADA, Kanagawa (JP); Mizue SEKINE, Kanagawa (JP)

(73) Assignee: FUJIFILM Business Innovation Corp., Tokyo (JP)

(21) Appl. No.: 18/589,728

(22) Filed: Feb. 28, 2024

(30) Foreign Application Priority Data
Sep. 27, 2023 (JP) 2023-164156

(51) Int. Cl. G03G 15/08

(52) U.S. Cl. CPC G03G 15/0865; G03G 15/0891

(57) ABSTRACT

An image forming apparatus includes: an image bearing member; a developing device that causes a developer to adhere onto the image bearing member; and a supplying device that supplies the developer to the developing device, the supplying device including an inlet that receives the developer from upstream, an outlet used for discharging the received developer, and an opening that is provided separately from the inlet and the outlet and that allows an inside and an outside of the supplying device to communicate with each other.

### CROSS-REFERENCE TO RELATED APPLICATIONS

This application is based on and claims priority under 35 USC 119 from Japanese Patent Application No. 2023-164156 filed Sep. 27, 2023.

### BACKGROUND

### (i) Technical Field

The present disclosure relates to image forming apparatuses.

### (ii) Related Art

Japanese Patent No. 4633419 discloses a configuration in which a developer container of a developing device is provided with a partition plate and openings. The partition plate is disposed between a first screw and a second screw and partitions the developer container. The openings are provided at opposite ends of the partition plate.

Japanese Patent No. 4646654 discloses a configuration in which a filter is provided above a toner refilling port.

Japanese Patent No. 6217553 discloses a configuration including a suction unit that suctions air inside a toner transport unit via a ventilation port, and also including a filter that is provided in the ventilation port and that captures toner contained in the air suctioned by the suction unit.

### SUMMARY

In a developing device that causes a developer to adhere to an image bearing member that retains an image, the internal pressure may rise in accordance with the operation of the developing device.

If the internal pressure of the developing device is to be released outside the developing device, an opening for releasing the internal pressure is provided near the internal space of the developing device. In this case, the developer in the developing device may leak outside the developing device via the opening, or a large amount of the developer may be supplied to a filter provided in the opening, thus shortening the lifespan of the filter.

Aspects of non-limiting embodiments of the present disclosure relate to an ability to release the internal pressure of the developing device at a location other than the developing device.

Aspects of certain non-limiting embodiments of the present disclosure address the above advantages and/or other advantages not described above. However, aspects of the non- limiting embodiments are not required to address the advantages described above, and aspects of the non-limiting embodiments of the present disclosure may not address advantages described above.

According to an aspect of the present disclosure, there is provided an image forming apparatus comprising: an image bearing member; a developing device that causes a developer to adhere onto the image bearing member; and a supplying device that supplies the developer to the developing device, the supplying device including an inlet that receives the developer from upstream, an outlet used for discharging the received developer, and an opening that is provided separately from the inlet and the outlet and that allows an inside and an outside of the supplying device to communicate with each other.

### BRIEF DESCRIPTION OF THE DRAWINGS

Exemplary embodiments of the present disclosure will be described in detail based on the following figures, wherein:

FIG. 1 illustrates an image forming apparatus;

FIG. 2 illustrates a developing device, as viewed from above;

FIG. 3 is a cross-sectional view of the developing device, taken along line III-III in FIG. 2;

FIG. 4 is a cross-sectional view of the developing device, taken along line IV-IV in FIG. 2;

FIG. 5 is a cross-sectional view of the developing device, taken along line V-V in FIG.

2;

FIG. 6 is a cross-sectional view of the developing device, taken along line VI-VI in FIG. 5;

FIG. 7 is a perspective view of a supplying device, as viewed from the rear side of the image forming apparatus;

FIG. 8 illustrates a developer accumulation section;

FIGS. 9A and 9B illustrate a filling portion, a gas flow path, and so on;

FIG. 10 is a perspective view of the developer accumulation section, as viewed from above;

FIG. 11 is an enlarged view of a first end of the developer accumulation section;

FIG. 12 illustrates a state where an upper member is attached on a lower container;

FIG. 13 is a cross-sectional view of the supplying device, taken along line XIII-XIII in FIG. 7;

FIG. 14 is a cross-sectional view of the supplying device, taken along a plane orthogonal to the longitudinal direction of a developer container;

FIG. 15 illustrates the flow of gas when the supplying device is viewed from above;

FIG. 16 illustrates another configuration example of the supplying device;

FIG. 17 illustrates the supplying device according to a second exemplary embodiment;

FIG. 18 is a cross-sectional view of a lower flow path, taken along line XVIII-XVIII in FIG. 17;

FIG. 19 illustrates the developer accumulation section according to the second exemplary embodiment, as viewed from above; and

FIG. 20 is a cross-sectional view of the supplying device, taken along line XX-XX in FIG. 17.

### DETAILED DESCRIPTION

Exemplary embodiments of the present disclosure will be described below with reference to the appended drawings.

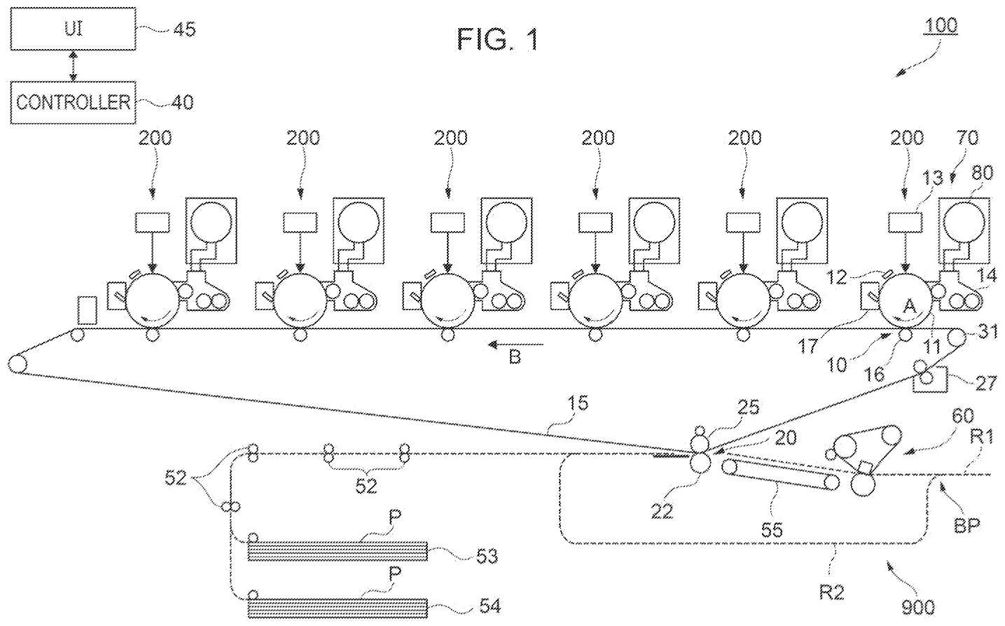

FIG. 1 illustrates an image forming apparatus 100 according to an exemplary embodiment. FIG. 1 illustrates the image forming apparatus 100 as viewed from the front side of the image forming apparatus 100.

The image forming apparatus 100 is an intermediate-transfer image forming apparatus of a so-called tandem type.

The image forming apparatus 100 is provided with multiple image forming units 200 that form images to be transferred onto a sheet P as an example of a recording medium.

Each image forming unit 200 includes a photoconductor drum 11 as an example of an image bearing member and forms a toner image onto the photoconductor drum 11 by using a developer that contains a toner. The toner image is an image to be transferred onto the sheet P. In other words, each image forming unit 200 forms a toner image, to be transferred onto the sheet P, onto the photoconductor drum 11 by using a developer in a powder form.

The developer according to this exemplary embodiment contains a dry carrier and a dry toner. Each image forming unit 200 forms the toner image onto the photoconductor drum 11 by using the carrier and the toner.

Six image forming units 200 form toner images onto the photoconductor drums 11 by using developers of different types.

In detail, in this exemplary embodiment, four image forming units 200 of the six image forming units 200 form toner images by using developers of basic colors, namely, yellow, magenta, cyan, and black colors.

The two remaining image forming units 200 form toner images by using developers of colors other than the basic colors. Such colors include clear, white, gold, silver, pink, green, and orange colors.

Other examples of developers of colors other than the basic colors include a developer containing a magnetic toner and a developer containing an electrically-conductive toner. Moreover, another example of a developer of a color other than the basic colors include a developer containing a toner that emits light by being irradiated with light, such as ultraviolet light or infrared light.

Although each developer used in this exemplary embodiment is a so-called two-component developer having a mixture of a carrier and a toner, each developer used is not limited thereto and may be a so-called one-component developer containing a toner alone.

The image forming apparatus 100 is also provided with an intermediate transfer belt 15 and first-transfer units 10 for transferring the toner images formed at the respective image forming units 200 onto the intermediate transfer belt 15.

Furthermore, the image forming apparatus 100 is provided with a second-transfer unit 20 for transferring the toner images transferred on the intermediate transfer belt 15 onto the sheet P.

Moreover, the image forming apparatus 100 is provided with a fixing device 60 where the toner images transferred on the sheet P are fixed onto the sheet P.

Furthermore, the image forming apparatus 100 is provided with a controller 40 including a central processing unit (CPU) that executes a program. The controller 40 controls each unit of the image forming apparatus 100.

The image forming apparatus 100 is also provided with a user interface (UI) 45 constituted of a display panel. The UI 45 receives a command from a user and displays information to the user.

Each image forming unit 200 is provided with a developing device 14. Each image forming unit 200 is also provided with a supplying device 70 that supplies a developer to the developing device 14.

The developing device 14 causes the developer to adhere onto the photoconductor drum 11. Accordingly, an electrostatic latent image on the photoconductor drum 11 is turned into a visible image by the toner. In other words, the developing device 14 performs a developing process on the photoconductor drum 11 serving as an image bearing member so as to form an image formed of the toner onto the photoconductor drum 11.

The supplying device 70 supplies a new developer to the developing device 14.

The supplying device 70 transports the developer from a developer container 80 attached to the image forming apparatus 100 toward the developing device 14, so as to supply the developer to the developing device 14.

As mentioned above, each developer contains a carrier and a toner, and the supplying device 70 refills the developing device 14 with the carrier and the toner serving as the developer. In this exemplary embodiment, the carrier has a positive charge polarity, whereas the toner has a negative charge polarity.

In each image forming unit 200, the photoconductor drum 11 serving as an image bearing member rotates in a direction indicated by an arrow A.

Furthermore, each image forming unit 200 is provided with a charging device 12 that electrostatically charges the photoconductor drum 11, and is also provided with an exposure device 13 that forms an electrostatic latent image on the photoconductor drum 11. The exposure device 13 includes a light source, such as a light-emitting diode (LED), and forms the electrostatic latent image on the photoconductor drum 11 by irradiating the photoconductor drum 11 with light.

Each image forming unit 200 is provided with a first-transfer roller 16 that transfers the toner image formed on the photoconductor drum 11 onto the intermediate transfer belt 15 at the corresponding first-transfer unit 10. Moreover, each image forming unit 200 is provided with a drum cleaner 17 that removes the developer remaining on the photoconductor drum 11.

The intermediate transfer belt 15 is circulated at a predetermined speed in the direction of an arrow B illustrated in FIG. 1 by a driving roller 31 driven by a motor (not illustrated).

Each first-transfer unit 10 includes a first-transfer roller 16 disposed facing the corresponding photoconductor drum 11 with the intermediate transfer belt 15 interposed therebetween. The toner images on the respective photoconductor drums 11 are electrostatically suctioned in sequence onto the intermediate transfer belt 15, so that a superposed toner image is formed on the intermediate transfer belt 15.

The second-transfer unit 20 as an example of a transfer unit includes a second-transfer roller 22 disposed on the outer surface of the intermediate transfer belt 15 and a backup roller 25 disposed on the inner surface of the intermediate transfer belt 15.

In this exemplary embodiment, the second-transfer unit 20 transfers the toner images formed by the image forming units 200 and transferred on the intermediate transfer belt 15 onto the sheet P transported to the second-transfer unit 20.

Furthermore, in this exemplary embodiment, a turnover mechanism 900 that turns over the sheet P is provided.

The turnover mechanism 900 turns over the sheet P having the toner images transferred on one surface thereof at the second-transfer unit 20, and supplies the sheet P again to the second-transfer unit 20.

Accordingly, in this exemplary embodiment, toner images are formable onto both surfaces of the sheet P.

The turnover mechanism 900 feeds the sheet P that has traveled through the fixing device 60 toward a branch path R2 branching off from a sheet transport path R1, so as to turn over the sheet P.

More specifically, after the sheet P has traveled through a branch portion BP, the turnover mechanism 900 transports the sheet P in the reverse direction and further feeds the sheet P to the branch path R2.

The branch path R2 merges with the sheet transport path R1 upstream of the second-transfer unit 20. Accordingly, in this exemplary embodiment, the turned-over sheet P is supplied again to the second-transfer unit 20. In this case, toner images are formed on both one surface of the sheet P and the other surface thereof, so that the toner images are formed on both surfaces of the sheet P.

The flow of a process performed in the image forming apparatus 100 will now be described.

For example, the image forming apparatus 100 receives image data output from an image reading device or a computer (not illustrated). Then, image processing is performed on the image data. Accordingly, image data corresponding to each of the multiple image forming units 200 is generated.

In detail, for example, image data used for forming images by using the developers of the basic colors, namely, yellow, magenta, cyan, and black colors, and image data used for forming images by using the developers of colors other than the basic colors are generated.

The generated image data is output to the exposure device 13 provided in each image forming unit 200.

The exposure device 13 radiates light output from the light source onto the photoconductor drum 11 in accordance with the input image data.

In this exemplary embodiment, the surface of each photoconductor drum 11 is electrostatically charged by the charging device 12, and the surface is subsequently scanned and exposed to light by the exposure device 13. Accordingly, an electrostatic latent image is formed on the surface of the photoconductor drum 11.

Then, the developing device 14 performs a developing process, thus causing the toner contained in the developer to adhere onto the photoconductor drum 11. Accordingly, a toner image is formed on the photoconductor drum 11. The toner image is transferred onto the intermediate transfer belt 15 at the corresponding first-transfer unit 10.

After each toner image is transferred onto the intermediate transfer belt 15, the intermediate transfer belt 15 moves so that the toner image moves to the second-transfer unit 20.

At this time, the sheet P from a first sheet container 53 or a second sheet container 54 is transported to the second-transfer unit 20 by, for example, a transport roller 52. Then, the toner images on the intermediate transfer belt 15 are collectively electrostatically transferred onto the sheet P at the second-transfer unit 20.

Subsequently, the sheet P having the toner images transferred thereon is separated from the intermediate transfer belt 15 and is transported to a transport belt 55. The transport belt 55 transports the sheet P to the fixing device 60.

The sheet P transported to the fixing device 60 receives heat and pressure at the fixing device 60. Accordingly, the toner images on the sheet P are fixed onto the sheet P. Then, the sheet P is output from the image forming apparatus 100.

When toner images are to be formed on both surfaces of the sheet P, after the sheet P travels through the fixing device 60, the sheet P is supplied again to the second-transfer unit 20 via the branch path R2.

Then, toner images are transferred onto the other surface of the sheet P at the second-transfer unit 20. Subsequently, the sheet P travels through the fixing device 60 again, so that the toner images transferred on the other surface are fixed onto the sheet P.

The developing devices 14 will now be described.

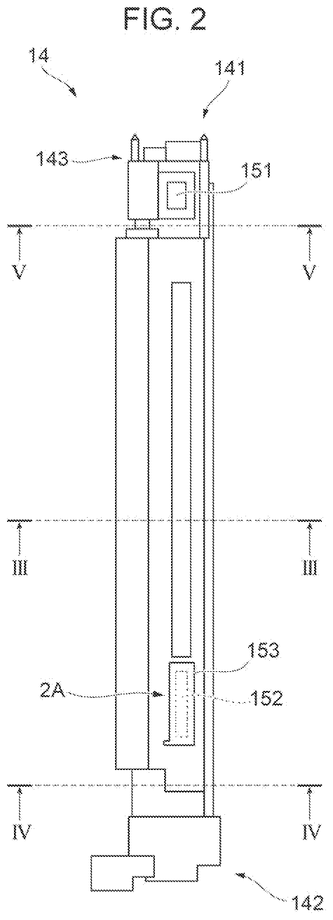

FIG. 2 illustrates each developing device 14, as viewed from above.

When the developing devices 14 are to be installed in the image forming apparatus 100, the developing devices 14 are disposed in the depth direction of the image forming apparatus 100. Each developing device 14 has a first end 141 and a second end 142 that are positionally different from each other in the longitudinal direction.

Each developing device 14 is installed in the image forming apparatus 100 such that the first end 141 is located at the rear side of the image forming apparatus 100 and the second end 142 is located at the front side of the image forming apparatus 100.

The first end 141 of the developing device 14 is provided with a driving-force receiver 143 that receives a driving force. A driving force from a driving source (not illustrated), such as a motor, provided in the body of the image forming apparatus 100 is transmitted to the driving-force receiver 143.

The driving-force receiver 143 operates in conjunction with, for example, a transport member (to be described later) provided inside the developing device 14. The driving force from the driving source is transmitted to the driving-force receiver 143, so that, for example, the transport member is rotated.

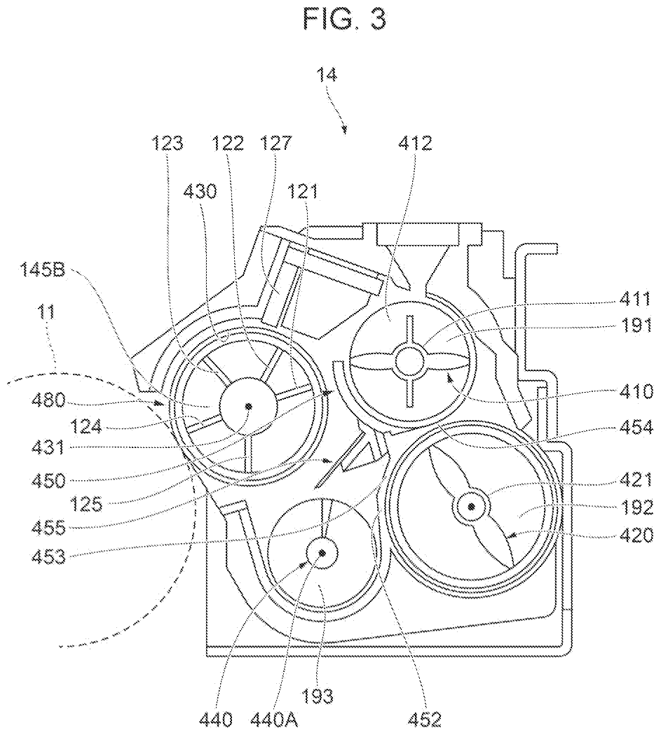

FIG. 3 is a cross-sectional view of the developing device 14, taken along line III-III in FIG. 2. The cross section illustrated in FIG. 3 is taken through a central portion of the developing device 14 in the longitudinal direction.

The developing device 14 is provided with a one-direction movement path 191 along which the developer moves in one direction.

The developing device 14 is also provided with an opposite-direction movement path 192 along which the developer moves in the opposite direction from the aforementioned one direction. The opposite-direction movement path 192 is disposed below the one-direction movement path 191.

The developer moves along the one-direction movement path 191 in a direction orthogonal to the plane of the drawing in FIG. 3 and also toward the rear side of the drawing. Furthermore, the developer moves along the opposite-direction movement path 192 in the direction orthogonal to the plane of the drawing in FIG. 3 and also toward the front side of the drawing.

The one-direction movement path 191 is provided with a one-direction transport member 410 that transports the developer. In this exemplary embodiment, the one-direction transport member 410 rotates about a rotation shaft 411 extending along the one-direction movement path 191, so that the developer moves toward the rear side.

The opposite-direction movement path 192 is provided with an opposite-direction transport member 420 that transports the developer. The opposite-direction transport member 420 is disposed below the one-direction transport member 410.

In this exemplary embodiment, the opposite-direction transport member 420 rotates about a rotation shaft 421 extending along the opposite-direction movement path 192, so that the developer moves toward the front side.

In this exemplary embodiment, the opposite-direction transport member 420 transports the developer in the opposite direction from the aforementioned one direction.

Furthermore, a rotating member 430 used for supplying the developer to the photoconductor drum 11 serving as an example of an image bearing member is provided to the left of the one-direction transport member 410.

Moreover, the developing device 14 is provided with a facing opening 480 that is disposed at a position facing the photoconductor drum 11 and where the rotating member 430 is installed. In this exemplary embodiment, the rotating member 430 is partially exposed through the facing opening 480.

The rotating member 430 supplies the developer supplied from the one-direction transport member 410 to the photoconductor drum 11. The rotating member 430 receives the developer supplied from the one-direction transport member 410 and supplies the developer to the photoconductor drum 11.

The rotating member 430 is constituted of a cylindrical member. For example, the rotating member 430 is composed of metal, such as steel use stainless (SUS).

The rotating member 430 rotates counterclockwise in the drawing about an axis 431 serving as a rotation axis, so as to move the developer supplied from the one-direction transport member 410 and adhered to the outer peripheral surface of the rotating member 430 toward the photoconductor drum 11. Accordingly, the developer is supplied to the photoconductor drum 11, so that the toner contained in the developer adheres to the surface of the photoconductor drum 11.

Furthermore, in this exemplary embodiment, a first movement regulator 450 is disposed between the rotating member 430 and the one-direction transport member 410 and is provided to regulate the movement of a portion of the developer moving from the one-direction transport member 410 toward the rotating member 430.

In this exemplary embodiment, of the developer existing in the one-direction movement path 191, the developer that has passed beyond the first movement regulator 450 is supplied to the rotating member 430.

Moreover, in this exemplary embodiment, a downward transport member 440 is disposed below the rotating member 430. The downward transport member 440 is a rotating member that rotates about an axis 440A extending in the aforementioned one direction.

The downward transport member 440 is disposed toward the photoconductor drum 11 relative to the opposite-direction transport member 420.

The downward transport member 440 transports the developer separated from the rotating member 430 in the direction orthogonal to the plane of the drawing in FIG. 3 and toward the rear side of the drawing.

The downward transport member 440 transports the developer separated from the rotating member 430 in the aforementioned one direction so that the developer is supplied toward a first end of the opposite-direction transport member 420 (to be described in detail later).

Furthermore, in this exemplary embodiment, a second movement regulator 452 is disposed between the downward transport member 440 and the opposite-direction transport member 420 and is provided to regulate the movement of the developer from the opposite-direction transport member 420 toward the downward transport member 440.

Moreover, a third movement regulator 453 is disposed between the rotating member 430 and the opposite-direction transport member 420 and is provided to regulate the movement of the developer from the opposite-direction transport member 420 toward the rotating member 430.

Furthermore, a fourth movement regulator 454 is disposed between the one-direction transport member 410 and the opposite-direction transport member 420 and is provided to regulate the movement of the developer from the one-direction transport member 410 toward the opposite-direction transport member 420 and the movement of the developer from the opposite-direction transport member 420 toward the one-direction transport member 410.

Moreover, a fifth movement regulator 455 is disposed between the rotating member 430 and the downward transport member 440 and is provided to regulate the movement of the developer from the downward transport member 440 toward the rotating member 430.

A magnet roller 145B is provided inside the rotating member 430.

The magnet roller 145B is provided with five magnetic poles 121 to 125 arranged in the circumferential direction of the magnet roller 145B.

The magnetic pole 121 is a pickup pole that suctions the developer supplied from the one-direction movement path 191. Accordingly, the developer adheres to the surface of the rotating member 430.

The magnetic poles 122 to 124 function as transport poles that move the developer on the surface of the rotating member 430 downstream in the rotational direction of the rotating member 430.

A facing regulator 127 is provided downstream of the magnetic pole 122 and upstream of the magnetic pole 123 in the rotational direction of the rotating member 430 and is located at a position facing the outer peripheral surface of the rotating member 430.

The facing regulator 127 is disposed with a gap from the rotating member 430. The facing regulator 127 regulates the movement of a portion of the developer adhered to the surface of the rotating member 430 and sets the thickness of the developer adhered to the surface of the rotating member 430 to a predetermined thickness.

When the developer on the surface of the rotating member 430 moves downstream in the rotational direction of the rotating member 430, the developer moves to the surface of the photoconductor drum 11, and the toner contained in the developer adheres to the photoconductor drum 11.

Accordingly, a developing process is performed, so that a toner image is formed on the surface of the photoconductor drum 11.

The toner image is temporarily retained on the photoconductor drum 11, and is moved to the corresponding first-transfer unit 10 (see FIG. 1) by the rotating photoconductor drum 11. Then, this image is transferred onto the intermediate transfer belt 15.

The magnetic pole 125 (see FIG. 3) functions as a pickoff pole that produces a repulsive magnetic field to cause the developer adhered to the surface of the rotating member 430 to separate from the rotating member 430.

The magnetic pole 125 causes the developer remaining on the surface of the rotating member 430 without being transferred onto the photoconductor drum 11 to separate from the rotating member 430.

The developer separated from the rotating member 430 moves downward and reaches a downward movement path 193.

The developer that has reached the downward movement path 193 is moved toward the first end 141 (see FIG. 2) of the developing device 14 by the downward transport member 440, and subsequently moves to the opposite-direction movement path 192 (to be described in detail later).

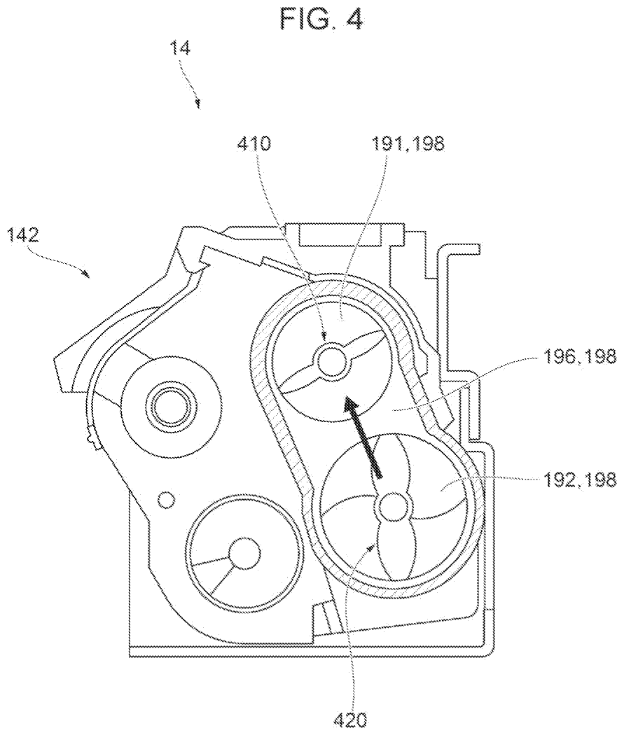

FIG. 4 is a cross-sectional view of the developing device 14, taken along line IV-IV in FIG. 2.

The cross section illustrated in FIG. 4 is taken through the second end 142 of the developing device 14.

The second end 142 of the developing device 14 is provided with an upward movement path 196 extending in the vertical direction. The developer moving along the opposite-direction movement path 192 travels toward the one-direction movement path 191 via the upward movement path 196.

In this exemplary embodiment, the developer accumulated at the downstream end of the opposite-direction movement path 192 in the developer movement direction is pushed by the developer sequentially transported from upstream, so as to travel toward the one-direction movement path 191 via the upward movement path 196.

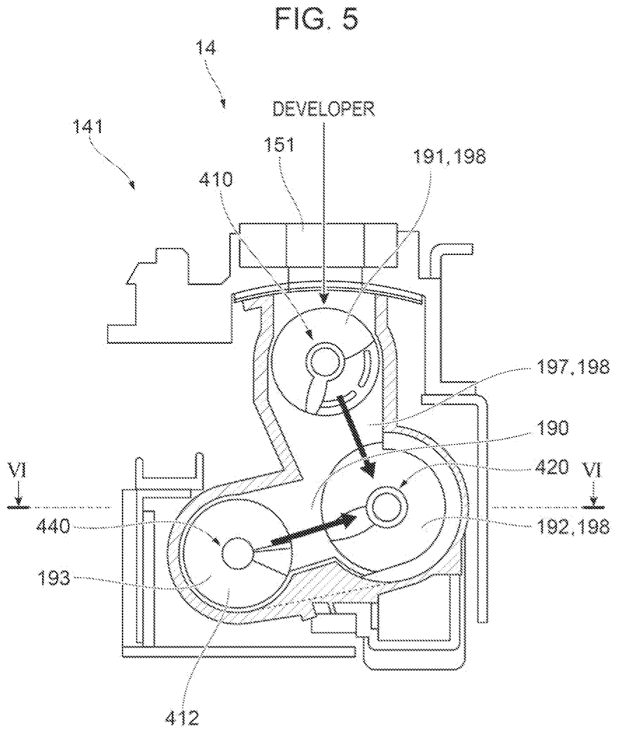

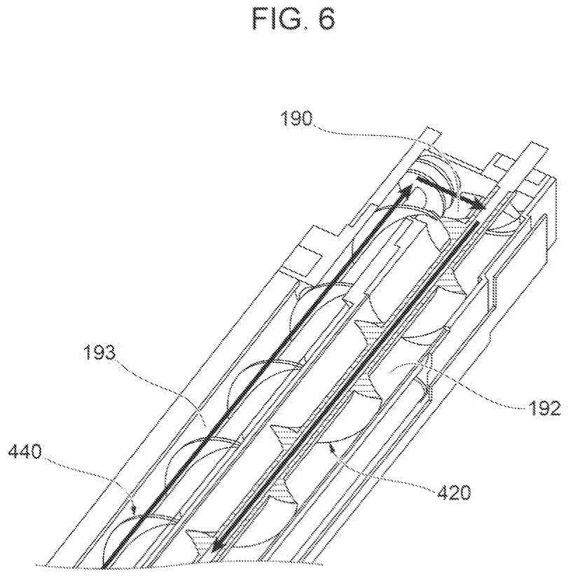

FIG. 5 is a cross-sectional view of the developing device 14, taken along line V-V in FIG. 2. FIG. 6 is a cross-sectional view of the developing device 14, taken along line VI-VI in FIG. 5.

The cross section illustrated in FIG. 5 is taken through the first end 141 of the developing device 14.

As illustrated in FIG. 5, the first end 141 of the developing device 14 is provided with a downward movement path 197 extending in the vertical direction.

In this exemplary embodiment, the developer moving along the one-direction movement path 191 travels toward the opposite-direction movement path 192 via the downward movement path 197.

Furthermore, as illustrated in FIGS. 5 and 6, in this exemplary embodiment, a connection path 190 that extends horizontally and that connects the downward movement path 193 and the opposite-direction movement path 192 to each other is provided.

In this exemplary embodiment, the developer moved along the downward movement path 193 by the downward transport member 440 travels toward the opposite-direction movement path 192 via the connection path 190.

In this exemplary embodiment, the developer accumulated at the downstream end of the downward movement path 193 in the developer movement direction is pushed by the developer sequentially transported from upstream, so as to move toward the opposite-direction movement path 192 via the connection path 190.

In this exemplary embodiment, the developer circulates by moving along the one-direction movement path 191 (see FIG. 3) and the opposite-direction movement path 192.

Then, a portion of the developer moving along the one-direction movement path 191 is supplied to the rotating member 430, and the developer is supplied to the photoconductor drum 11 via the rotating member 430.

The developer remaining on the rotating member 430 without being supplied to the photoconductor drum 11 is separated from the rotating member 430 and reaches the downward movement path 193. Then, the developer moves toward the opposite-direction movement path 192 via the downward movement path 193.

Furthermore, as illustrated in FIG. 2, in this exemplary embodiment, the developing device 14 is provided with a first inlet 151 for receiving the developer. The developing device 14 receives the developer transported from the supplying device 70 via the first inlet 151.

As illustrated in FIG. 5, in this exemplary embodiment, the developer transported from the supplying device 70 enters the developing device 14 via the first inlet 151.

Moreover, in this exemplary embodiment, an area indicated with reference sign 2A in FIG. 2 is provided with a second inlet 152. The second inlet 152 is blocked by a blocking member 153.

In this exemplary embodiment, a user may manually supply a new developer to the developing device 14 by using a tool (not illustrated). When the user is to manually supply a new developer, the user first removes the blocking member 153. Then, the user supplies the developer to the developing device 14 through the second inlet 152 that appears as a result of removing the blocking member 153.

Furthermore, as illustrated in FIG. 3, the developing device 14 according to this exemplary embodiment is provided with the facing opening 480 that is disposed facing the photoconductor drum 11 and where the rotating member 430 is installed.

In this exemplary embodiment, the first inlet 151, the second inlet 152, and the facing opening 480 are provided in this manner.

In this exemplary embodiment, other than the first inlet 151, the second inlet 152, and the facing opening 480, the developing device 14 is not provided with a connection opening as an opening that allows the inside and the outside of the developing device 14 to communicate with each other.

In this exemplary embodiment, the internal pressure of the developing device 14 is released through an opening provided in the supplying device 70 instead of through a connection opening provided in the developing device 14.

In this exemplary embodiment, the developer adhered to the surface of the rotating member 430 returns to the developing device 14 without being transferred onto the photoconductor drum 11, so that the air outside the developing device 14 is taken into the developing device 14. Accordingly, the internal pressure of the developing device 14 increases.

In this exemplary embodiment, the internal pressure of the developing device 14 increases so that gas moving outward from the inside of the developing device 14 travels toward the supplying device 70 (see FIG. 1). This gas is discharged outward from the supplying device 70 via an opening (not illustrated in FIG. 1) provided in the supplying device 70. An example of the gas is air.

As an alternative to excluding a configuration where a connection opening is provided in the developing device 14, the developing device 14 may be provided with a connection opening, and the supplying device 70 may be provided with an opening.

In this case, the gas moving outward from the inside of the developing device 14 is discharged outward from the developing device 14 via both the connection opening and the opening provided in the supplying device 70.

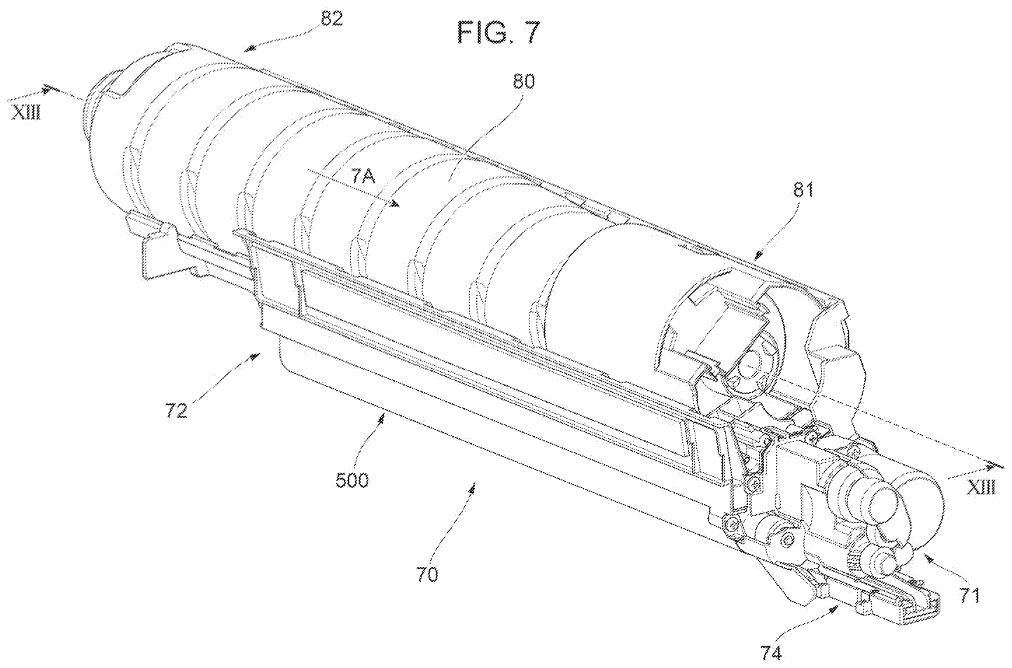

FIG. 7 is a perspective view of the supplying device 70, as viewed from the rear side of the image forming apparatus 100. FIG. 7 illustrates the developer container 80 in an attached state.

In this exemplary embodiment, the developer container 80 containing an unused developer is attachable to and detachable from the image forming apparatus 100 (see FIG. 1).

When the developer container 80 is to be attached to the image forming apparatus 100, the developer container 80 is moved in a direction indicated by an arrow 7A in FIG. 7, so that the developer container 80 is attached to the image forming apparatus 100.

When the developer container 80 is attached to the image forming apparatus 100, the supplying device 70 is positioned below the developer container 80.

The developer container 80 has a first end 81 to be located at the leading end when the developer container 80 is to be attached to the image forming apparatus 100, and also has a second end 82 located opposite the first end 81.

A developer outlet is provided at and below the first end 81 of the developer container 80. The developer in the developer container 80 moves toward the supplying device 70 located therebelow via the outlet.

The supplying device 70 has a first end 71 and a second end 72.

The first end 71 of the supplying device 70 is located at the rear surface of the image forming apparatus 100, whereas the second end 72 of the supplying device 70 is located at the front surface of the image forming apparatus 100.

The first end 71 of the supplying device 70 is provided with an inlet (not illustrated in FIG. 7) for receiving the developer from the developer container 80.

In other words, the first end 71 of the supplying device 70 is provided with the inlet that receives the developer transported toward the supplying device 70 from upstream of the supplying device 70 in the developer transport direction.

The developer container 80 has a function for delivering the developer contained therein to the outside.

In the developer transport direction, the developer container 80 is located upstream of the supplying device 70. The inlet of the supplying device 70 receives the developer supplied from the developer container 80 located upstream.

Furthermore, the supplying device 70 is provided with a developer accumulation section 500 where the developer entering the supplying device 70 via the inlet accumulates.

The developer supplied to the supplying device 70 from the developer container 80 is temporarily contained in the developer accumulation section 500. Accordingly, the developer is temporarily accumulated in the developer accumulation section 500.

After moving through the developer accumulation section 500, the developer is discharged from an outlet 74 provided at the first end 71 of the supplying device 70.

The supplying device 70 is provided with the outlet 74 used for discharging the developer received at the inlet. The developer discharged from the outlet 74 is supplied to the developing device 14 (not illustrated in FIG. 7) located below the outlet 74.

In this exemplary embodiment, the first inlet 151 (see FIG. 2) provided in the developing device 14 is disposed directly below the outlet 74 of the supplying device 70.

The developer discharged from the outlet 74 moves into the developing device 14 via the first inlet 151. Accordingly, the developer is supplied to the developing device 14 from the supplying device 70.

As described above, in this exemplary embodiment, the developer is temporarily contained in the developer accumulation section 500.

Accordingly, for example, even when the developer container 80 is detached due to the developer container 80 being empty, the developer is still supplied from the supplying device 70 to the developing device 14.

Even when the developer container 80 is detached, the developer in the developer accumulation section 500 is supplied to the developing device 14. Accordingly, even when the developer container 80 is detached, the developer is still supplied from the supplying device 70 to the developing device 14.

In this case, even when the developer container 80 is detached, an immediate stoppage of the image forming operation may be avoided. In this case, the image forming operation may be continuously performed until a new developer container 80 is attached.

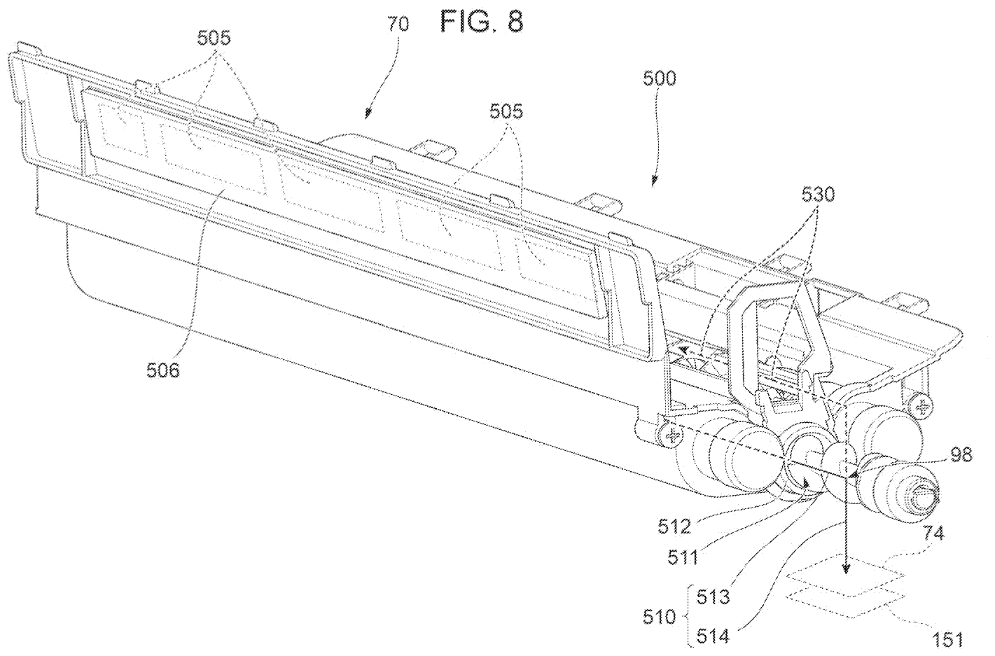

FIG. 8 illustrates the developer accumulation section 500.

The developer accumulation section 500 is provided with a developer flow path 510 along which the developer moving toward the developing device 14 travels.

The developer flow path 510 illustrated in FIG. 8 extends from the inside toward the outside of the developer accumulation section 500.

In this exemplary embodiment, the developer flow path 510 has a filling portion 511 where the developer fills over the entire cross section of the developer flow path 510.

In this description, the term “cross section” of the developer flow path 510 refers to the cross section of the developer flow path 510 taken along a plane orthogonal to the extending direction of the developer flow path 510.

The filling portion 511 is surrounded by a tubular portion 512. In this exemplary embodiment, the inner side of the tubular portion 512 serves as the filling portion 511.

In a cross section within the tubular portion 512 and orthogonal to the axial direction of the tubular portion 512, the developer fills the entire inner side of the tubular portion 512 and is in a scaled state. Accordingly, in this exemplary embodiment, the filling portion 511 filled with the developer is formed within the tubular portion 512.

In the configuration where the filling portion 511 is formed, the amount of developer supplied per unit time from the supplying device 70 to the developing device 14 is stabilized.

In a case where there is no filling portion 511, sparseness occurs in the developer traveling toward the developing device 14, thus causing the amount of developer supplied per unit time from the supplying device 70 to the developing device 14 to fluctuate.

The developer flow path 510 changes direction and extends downward at the downstream side of the filling portion 511 in the developer transport direction.

The developer flow path 510 is provided with a horizontal flow path 513 extending in the horizontal direction and a vertical flow path 514 extending in the vertical direction.

The developer that has passed through the filling portion 511 travels along the horizontal flow path 513 to move away from the filling portion 511. Then, the developer travels along the vertical flow path 514 to move downward. The developer falls downward along the vertical flow path 514.

The outlet 74 of the supplying device 70 and the first inlet 151 of the developing device 14 are provided below the vertical flow path 514. The developer traveling downward along the vertical flow path 514 is supplied to the developing device 14.

Furthermore, in this exemplary embodiment, a gas flow path 530 is provided separately from the developer flow path 510 and serves as a path along which the gas flowing from the developing device 14 toward the supplying device 70 travels.

As mentioned above, in this exemplary embodiment, the gas flows from the developing device 14 toward the supplying device 70 as the internal pressure of the developing device 14 increases.

The gas flowing from the developing device 14 toward the supplying device 70 enters the supplying device 70 through the outlet 74 of the supplying device 70 and subsequently travels upward via the vertical flow path 514. Then, the gas enters the gas flow path 530 branching off from the developer flow path 510.

The gas entering the gas flow path 530 travels toward an opening 505 provided in the supplying device 70, and is discharged from the opening 505. The opening 505 has a filter 506 set therein. In FIG. 8, the opening 505 is provided behind the filter 506.

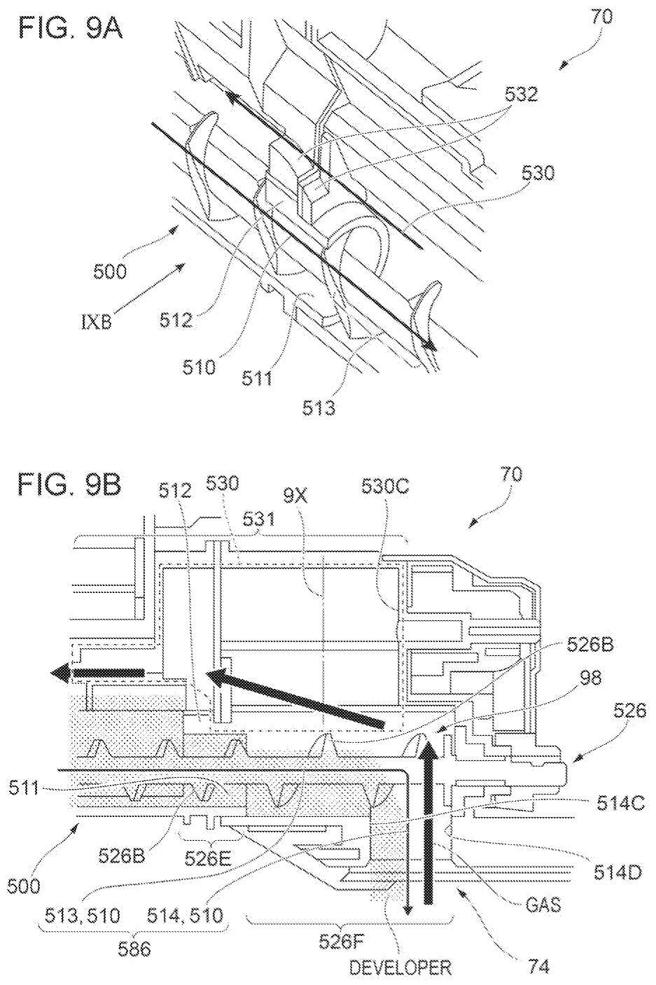

FIGS. 9A and 9B illustrate the filling portion 511, the gas flow path 530, and so on. FIG. 9A is a perspective view of the filling portion 511, the gas flow path 530, and so on, and FIG. 9B illustrates the filling portion 511, the gas flow path 530, and so on, as viewed from a direction indicated by an arrow IXB in FIG. 9A.

As mentioned above and as illustrated in FIG. 9A, in this exemplary embodiment, the developer flow path 510 is provided to extend from the inside toward the outside of the developer accumulation section 500.

The filling portion 511 is located in the developer flow path 510 and within the tubular portion 512.

Furthermore, in this exemplary embodiment, the gas flow path 530 is provided above the tubular portion 512 in the drawings. In other words, the gas flow path 530 is provided above the filling portion 511.

As illustrated in FIG. 8, the gas flow path 530 branches off from the developer flow path 510.

In this exemplary embodiment, a branch portion 98 is provided as an example of a branch area where the gas flow path 530 branches off from the developer flow path 510. The branch portion 98 is located downstream of the filling portion 511 in the developer transport direction.

In this exemplary embodiment, the gas flow path 530 branches off from the developer flow path 510 downstream of the filling portion 511 in the developer transport direction.

As illustrated in FIG. 9A, after branching off from the developer flow path 510, the gas flow path 530 extends above the filling portion 511. The gas traveling along the gas flow path 530 travels above the filling portion 511. The gas traveling along the gas flow path 530 travels through an area other than the filling portion 511 and moves upstream in the developer movement direction.

In the filling portion 511, the developer is in a sealed state, and it is difficult for the gas to travel through the filling portion 511. In this exemplary embodiment, the area other than the filling portion 511 is provided with the gas flow path 530 for allowing the gas to travel therethrough.

As illustrated in FIG. 8, the gas flow path 530 extends from the branch portion 98 toward the tubular portion 512, further extends above the tubular portion 512, and extends upstream in the developer movement direction.

As will be described later, the gas flow path 530 is connected again to an internal space of the supplying device 70 upstream of the filling portion 511 in the developer movement direction.

The gas flow path 530 is connected again to the internal space of the supplying device 70 in an area other than the branch portion 98 where the gas flow path 530 branches off from the developer flow path 510.

As illustrated in FIG. 9B, in this exemplary embodiment, the gas from the developing device 14 first travels along the vertical flow path 514 provided as a part of the developer flow path 510, and travels upstream in the developer movement direction.

Subsequently, the gas temporarily enters the horizontal flow path 513, and then enters the gas flow path 530 located above the horizontal flow path 513. Then, the gas moves leftward in the drawing by traveling along the gas flow path 530.

As illustrated in FIG. 9B, the gas flow path 530 extends horizontally, and the gas flow path 530 has a horizontal portion 531 as a horizontally-extending portion.

In this exemplary embodiment, as illustrated in FIG. 9A, the bottom surface of the horizontal portion 531 is given a slope 532 that is inclined relative to the horizontal direction. The slope 532 decreases in height toward the upstream side in the movement direction of the gas traveling along the gas flow path 530.

With the bottom surface being provided with the slope 532, the developer is less likely to accumulate at the bottom surface. The developer in the area given the slope 532 on the bottom surface of the gas flow path 530 moves in a sliding manner in the lower right direction in FIG. 9A.

The horizontal flow path 513 is located downstream in the lower right direction. The developer on the bottom surface of the gas flow path 530 moves toward the horizontal flow path 513.

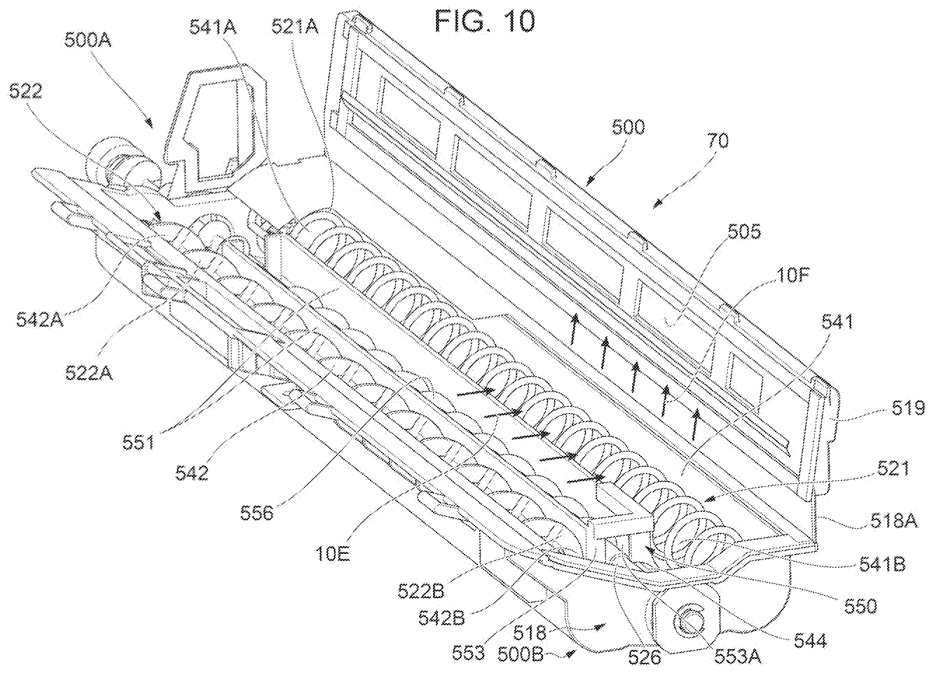

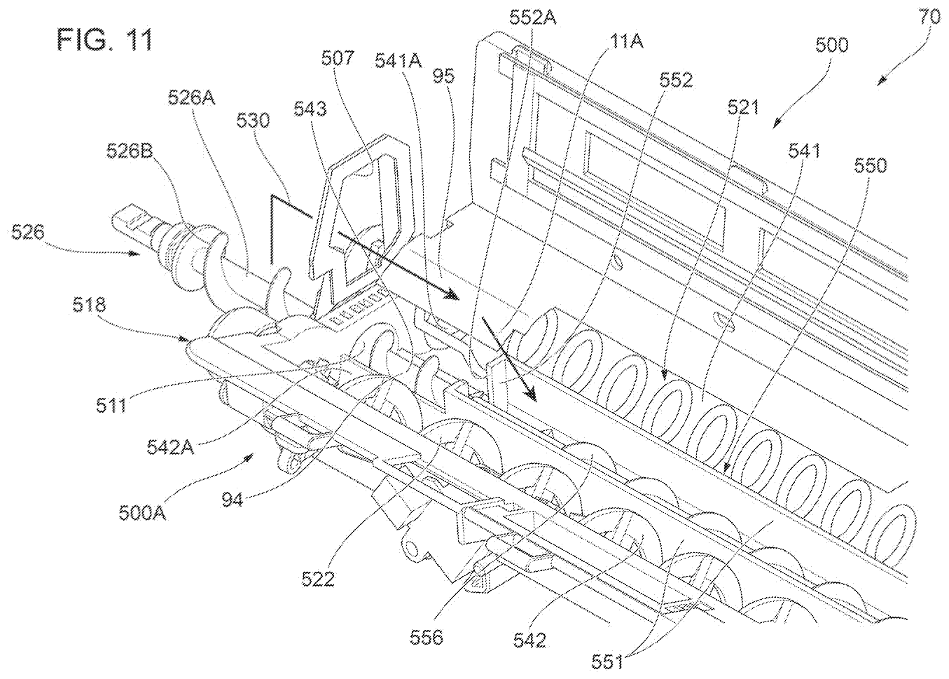

FIG. 10 is a perspective view of the developer accumulation section 500, as viewed from above. FIG. 11 is an enlarged view of a first end 500A of the developer accumulation section 500.

FIG. 10 illustrates the developer accumulation section 500, as viewed from a second end 500B of the developer accumulation section 500.

As illustrated in FIG. 10, the developer accumulation section 500 is provided with a rectangular-parallelepiped lower container 518 that accommodates the developer supplied from the developer container 80 (not illustrated in FIG. 10).

The lower container 518 is provided therein with a one-direction transport member 521 that transports the developer in one direction and an opposite-direction transport member 522 that transports the developer in the opposite direction from the one direction.

The one-direction transport member 521 and the opposite-direction transport member 522 are provided parallel to each other and extend in the longitudinal direction of the lower container 518.

Furthermore, in this exemplary embodiment, a driving source (not illustrated), such as a motor, is provided for driving the one-direction transport member 521 and the opposite-direction transport member 522.

The one-direction transport member 521 is constituted of a coil. In other words, the one-direction transport member 521 is formed by bending a wire in a helical shape.

The opposite-direction transport member 522 includes a rod-like rotation shaft (not illustrated) and a helical protrusion 522A disposed around the rotation shaft and protruding from the outer peripheral surface of the rotation shaft.

In this exemplary embodiment, the one-direction transport member 521 that is coil-shaped is rotated by the driving source about a rotation axis extending in the axial direction of the one-direction transport member 521. Accordingly, the developer gradually moves in the axial direction of the one-direction transport member 521.

In more detail, the developer moves toward a first end 521A of the one-direction transport member 521 in the axial direction.

Furthermore, in this exemplary embodiment, the opposite-direction transport member 522 is rotated about a rotation axis by the driving source. Accordingly, extrusion of the developer is performed by the protrusion 522A provided on the opposite-direction transport member 522, and the developer moves in the axial direction of the opposite-direction transport member 522.

In more detail, the developer moves toward a second end 522B of the opposite-direction transport member 522 in the axial direction.

Furthermore, the lower container 518 is provided therein with a one-direction flow path 541 serving as a flow path along which the developer travels when moving in one direction, and an opposite-direction flow path 542 serving as a flow path along which the developer travels when moving in the opposite direction from the one direction.

The one-direction flow path 541 and the opposite-direction flow path 542 are provided parallel to each other and extend in the longitudinal direction of the lower container 518.

The one-direction flow path 541 has the one-direction transport member 521 disposed therein. The developer transported by the one-direction transport member 521 moves within the one-direction flow path 541.

The opposite-direction flow path 542 has the opposite-direction transport member 522 disposed therein. The developer transported by the opposite-direction transport member 522 moves within the opposite-direction flow path 542.

Furthermore, as illustrated in FIG. 11, the first end 500A of the developer accumulation section 500 and the lower container 518 are provided therein with a first-end connection flow path 543 that connects a first end 541A of the one-direction flow path 541 and a first end 542A of the opposite-direction flow path 542 to each other.

Moreover, as illustrated in FIG. 10, the second end 500B of the developer accumulation section 500 and the lower container 518 are provided therein with a second-end connection flow path 544 that connects a second end 541B of the one-direction flow path 541 and a second end 542B of the opposite-direction flow path 542 to each other.

Furthermore, as illustrated in FIG. 10, the lower container 518 is provided therein with an annular wall 550 serving as an annularly-extending wall.

When the lower container 518 is viewed from above, the annular wall 550 has an annular shape. Moreover, when the lower container 518 is viewed from above, the annular wall 550 is rectangular.

The annular wall 550 is provided between the one-direction flow path 541 and the opposite-direction flow path 542. Moreover, the annular wall 550 is provided between the first-end connection flow path 543 (see FIG. 11) and the second-end connection flow path 544.

As illustrated in FIG. 10, the annular wall 550 protrudes upward from the bottom surface of the lower container 518. Moreover, the annular wall 550 extends in the longitudinal direction of the lower container 518.

The annular wall 550 is surrounded by the one-direction flow path 541, the opposite-direction flow path 542, the first-end connection flow path 543 (see FIG. 11), and the second-end connection flow path 544.

In this exemplary embodiment, the developer transported by the one-direction transport member 521 and the opposite-direction transport member 522 moves through a space located around the annular wall 550 within a space inside the lower container 518.

In more detail, the developer transported by the one-direction transport member 521 and the opposite-direction transport member 522 moves along the one-direction flow path 541, the first-end connection flow path 543 (see FIG. 11), the opposite-direction flow path 542, and the second-end connection flow path 544 in that order.

In other words, the developer transported by the one-direction transport member 521 and the opposite-direction transport member 522 circulates by moving around the annular wall 550.

In this exemplary embodiment, the developer transported by the one-direction transport member 521 travels toward the first end 541A of the one-direction flow path 541.

Then, the developer that has reached the first end 541A is pushed by the developer sequentially transported to the first end 541A from the upstream side of the one-direction transport member 521, so as to move toward the first-end connection flow path 543 (see FIG. 11). The developer then moves toward the opposite-direction flow path 542 via the first-end connection flow path 543.

The developer that has moved to the opposite-direction flow path 542 is moved toward the second end 542B of the opposite-direction flow path 542 (see FIG. 10) by the opposite-direction transport member 522.

The developer that has reached the second end 542B of the opposite-direction flow path 542 is pushed by the developer sequentially transported to the second end 542B from the upstream side of the opposite-direction transport member 522, so as to move toward the second-end connection flow path 544.

Then, the developer travels toward the one-direction flow path 541 via the second-end connection flow path 544.

Accordingly, in this exemplary embodiment, the developer circulates by moving around the annular wall 550.

The annular wall 550 has four wall portions.

The annular wall 550 is provided with two axial-direction wall portions 551 extending in the axial direction of the one-direction transport member 521 and the opposite-direction transport member 522 and disposed facing each other.

Moreover, as illustrated in FIG. 11, the annular wall 550 is provided with a first-end wall portion 552 that is located at a first longitudinal end of the annular wall 550 and that connects the two axial-direction wall portions 551 to each other.

Furthermore, as illustrated in FIG. 10, the annular wall 550 is provided with a second-end wall portion 553 that is located at a second longitudinal end of the annular wall 550 and that connects the two axial-direction wall portions 551 to each other.

Moreover, as illustrated in FIG. 11, the first end 500A of the developer accumulation section 500 is provided with an opening 507 through which the gas flow path 530 extends. The gas coming from the developing device 14 and traveling along the gas flow path 530 moves diagonally in the lower right direction via the opening 507.

Furthermore, in this exemplary embodiment, as illustrated in FIG. 10, an upward-extending wall portion 519 is provided above a sidewall 518A that is one of four sidewalls of the lower container 518 and that extends in the longitudinal direction of the lower container 518.

The wall portion 519 extends in the longitudinal direction of the lower container 518.

The wall portion 519 is provided with the opening 505 used for discharging the gas flowing from the developing device 14. There are multiple openings 505 provided. The multiple openings 505 are arranged in the longitudinal direction of the lower container 518.

In this exemplary embodiment, the gas traveling along the gas flow path 530 (see FIG. 11) is discharged outward from the supplying device 70 via the openings 505.

In this exemplary embodiment, the gas traveling along the gas flow path 530 (see FIG. 11) subsequently enters an interior wall space 556 serving as a space located within the annular wall 550, as illustrated in FIG. 11A.

Then, the gas travels through the interior wall space 556 and moves toward the second end 500B of the developer accumulation section 500 (see FIG. 10).

Subsequently, the gas travels toward the one-direction flow path 541, as indicated by an arrow 10E in FIG. 10.

Then, as indicated by an arrow 10F, the gas moves along the wall portion 519 and travels toward the openings 505 in the wall portion 519. The gas then moves outward from the supplying device 70 via the openings 505.

As illustrated in FIG. 11, the first end 500A of the developer accumulation section 500 is provided with the aforementioned filling portion 511.

In this exemplary embodiment, a center transport member 526 extending through the filling portion 511 is further provided. The center transport member 526 is provided at the center of the lower container 518 in the lateral direction of the lower container 518.

The center transport member 526 is disposed between the one-direction transport member 521 and the opposite-direction transport member 522. The center transport member 526 extends in the longitudinal direction of the lower container 518.

Moreover, in this exemplary embodiment, a driving source (not illustrated), such as a motor, is provided for driving the center transport member 526.

The center transport member 526 includes a rod-like rotation shaft 526A and a helical protrusion 526B disposed around the rotation shaft 526A and protruding from the outer peripheral surface of the rotation shaft 526A.

In this exemplary embodiment, the center transport member 526 is rotated about the rotation shaft 526A by the driving source. Accordingly, extrusion of the developer is performed by the protrusion 526B, and the developer moves in the axial direction of the center transport member 526.

In this exemplary embodiment, the developer that is inside the lower container 518 and that is within the first-end connection flow path 543 is delivered to the filling portion 511 by the center transport member 526.

The developer transported by the one-direction transport member 521 accumulates in the first-end connection flow path 543.

The first-end connection flow path 543 extends through a space 94 (referred to as “pre-filling space 94” hereinafter) located between the filling portion 511 and the first-end wall portion 552, and the developer transported by the one-direction transport member 521 accumulates in the pre-filling space 94.

In this exemplary embodiment, the developer accumulating in the pre-filling space 94 is pushed into the filling portion 511 by the center transport member 526.

Accordingly, the filling portion 511 is filled with the developer, and the developer is transported downstream.

The developer traveling through the filling portion 511 travels toward the developing device 14 via the horizontal flow path 513 (see FIG. 9B) and the vertical flow path 514 that are located downstream of the filling portion 511.

As illustrated in FIG. 10, the center transport member 526 extends from one longitudinal end to the other longitudinal end of the lower container 518.

The center transport member 526 extends through the annular wall 550. In other words, the center transport member 526 is partially located in the interior wall space 556.

As illustrated in FIG. 11, the first-end wall portion 552 of the annular wall 550 is provided with a recess 552A. The center transport member 526 extends through the recess 552A.

In this exemplary embodiment, with the first-end wall portion 552 provided, entry of the developer within the pre-filling space 94 into the interior wall space 556 may be suppressed.

Furthermore, in this exemplary embodiment, as illustrated in FIG. 10, the second-end wall portion 553 of the annular wall 550 is provided with an opening 553A. In this exemplary embodiment, the center transport member 526 extends through the opening 553A.

In this exemplary embodiment, with the second-end wall portion 553 provided, entry of the developer within the second-end connection flow path 544 into the interior wall space 556 may be suppressed.

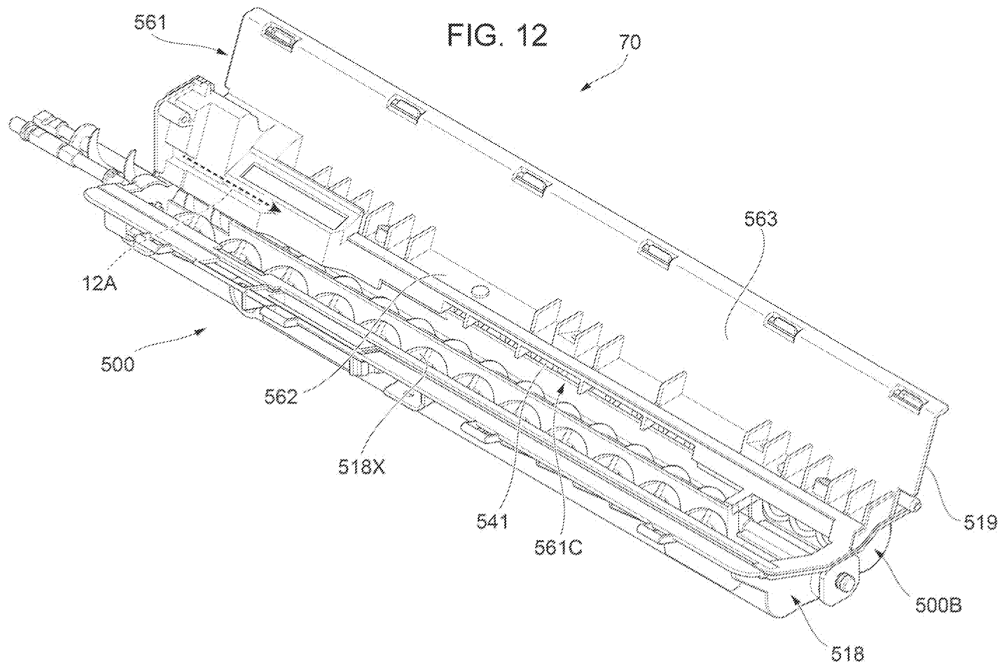

FIG. 12 illustrates a state where an upper member 561 is attached on the lower container 518.

In the supplying device 70, the upper member 561 is attached on the lower container 518.

The upper member 561 includes a horizontally-extending blocking portion 562 that blocks an opening 518X located at an upper area of the lower container 518 and an upward-extending wall portion 563 connected to the blocking portion 562.

The wall portion 563 is provided facing the wall portion 519 provided in the lower container 518. A gap for allowing the gas to flow therethrough is provided between the wall portion 563 provided in the upper member 561 and the wall portion 519 provided in the lower container 518.

In other words, a space (to be described later) for allowing the gas to flow therethrough is provided between the wall portion 563 provided in the upper member 561 and the wall portion 519 provided in the lower container 518.

As indicated by an arrow 12A in FIG. 12, the gas traveling through the opening 507 provided in the first end 500A of the developer accumulation section 500 (see FIG. 11) flows through the gap between the lower container 518 and the upper member 561 to travel toward the second end 500B of the developer accumulation section 500.

The gas flow path 530 (see FIG. 11) is provided between the lower container 518 and the upper member 561.

The gas traveling through the opening 507 flows along the gas flow path 530 located between the lower container 518 and the upper member 561, and travels toward the second end 500B of the developer accumulation section 500, as indicated by an arrow 12A.

Then, as indicated by an arrow 11A in FIG. 11, the gas traveling along the gas flow path 530 enters the interior wall space 556, travels through the interior wall space 556, and moves toward the second end 500B of the developer accumulation section 500.

Subsequently, the gas travels toward the one-direction flow path 541 via a recess 561C provided in the lower surface of the upper member 561 (see FIG. 12).

Then, the gas travels above the one-direction flow path 541 to move into a space located between the wall portion 563 and the wall portion 519.

The gas then travels upward through the space and moves outward from the supplying device 70 via the openings 505 (see FIG. 10) provided in the wall portion 519.

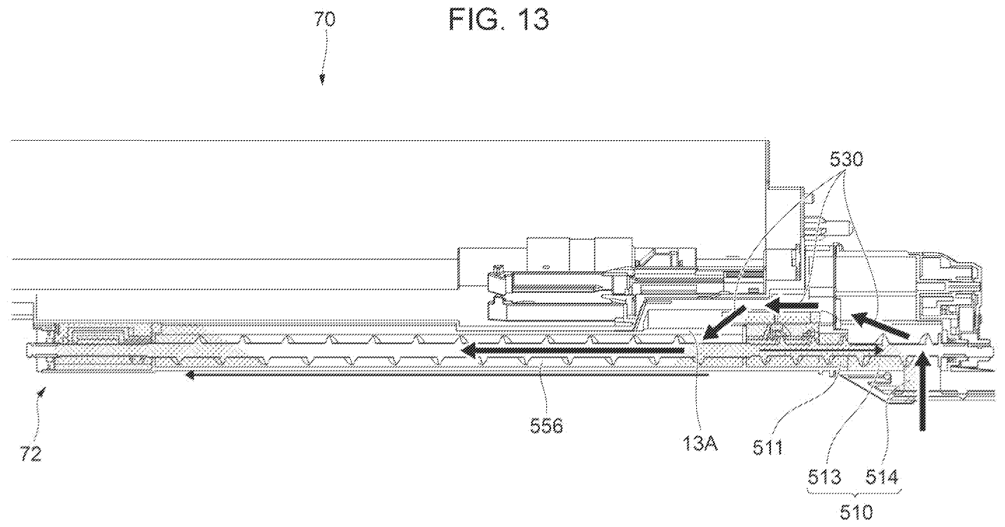

FIG. 13 is a cross-sectional view of the supplying device 70, taken along line XIII-XIII in FIG. 7. In FIG. 13, the developer container 80 illustrated in FIG. 7 is not omitted.

The flow of the gas in the supplying device 70 will be further described with reference to FIG. 13.

In this exemplary embodiment, the gas entering the supplying device 70 from the developing device 14 (not illustrated in FIG. 13) first travels upward along the vertical flow path 514 serving as a part of the developer flow path 510.

Subsequently, the gas travels toward the second end 72 of the supplying device 70 via the gas flow path 530 branching off from the developer flow path 510.

The gas flow path 530 is connected again to the space inside the supplying device 70 at a location indicated by reference sign 13A. In detail, at the location indicated by reference sign 13A, the gas flow path 530 connects to the interior wall space 556 located within the annular wall 550 (not illustrated in FIG. 13).

In this exemplary embodiment, the gas traveling along the gas flow path 530 is supplied to the interior wall space 556 in the space inside the supplying device 70.

The interior wall space 556 is not located in the developer flow path 510 but is located away from the developer flow path 510. Of the space inside the supplying device 70, the gas flow path 530 is connected to an area other than the developer flow path 510.

The gas entering the interior wall space 556 subsequently travels toward the one-direction flow path 541 via the recess 561C provided at the lower surface of the upper member 561 (see FIG. 12).

Then, the gas travels above the one-direction flow path 541 to move into the space located between the wall portion 563 and the wall portion 519.

The gas then travels upward through the space and subsequently travels through the openings 505 (see FIG. 10) in the wall portion 519.

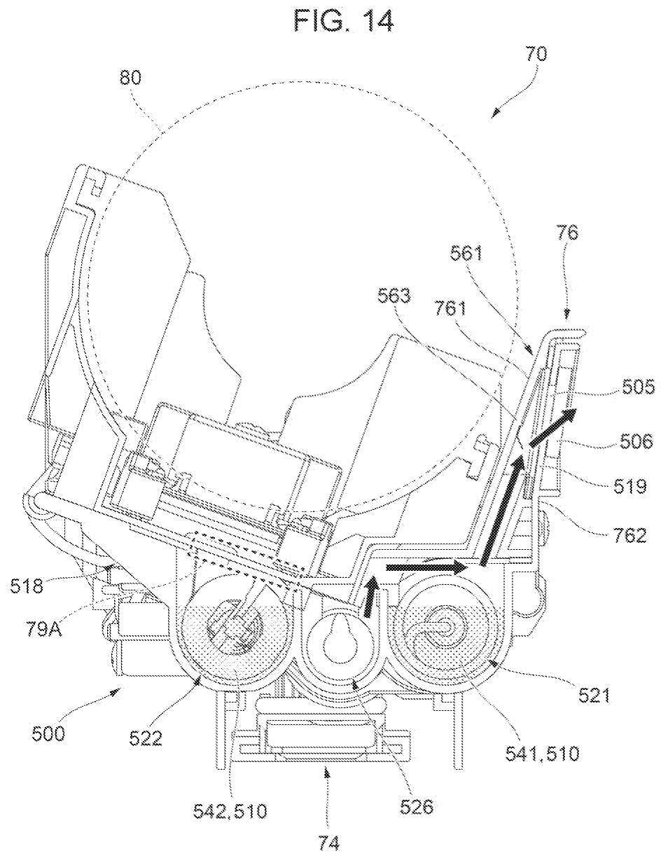

FIG. 14 is a cross-sectional view of the supplying device 70, taken along a plane orthogonal to the longitudinal direction of the developer container 80. In FIG. 14, the developer container 80 is indicated by a dashed line.

The supplying device 70 is provided with a protrusion 76 extending diagonally upward and having an internal cavity. In this exemplary embodiment, the protrusion 76 is provided with the openings 505 mentioned above.

In this exemplary embodiment, the wall portion 519 provided in the lower container 518 and the wall portion 563 provided in the upper member 561 constitute the protrusion 76. The wall portion 563 and the wall portion 519 are disposed in a relationship in which they protrude upward and face each other.

In this exemplary embodiment, the protrusion 76 extending upward is partially located alongside the developer container 80.

The protrusion 76 has a facing surface 761 facing the developer container 80 and an opposite surface 762 located opposite the facing surface 761.

Of the surfaces that the protrusion 76 has in this exemplary embodiment, the opposite surface 762 opposite the facing surface 761 facing the developer container 80 is provided with the openings 505. As mentioned above, the filter 506 is disposed at a position facing each opening 505.

As illustrated in FIG. 14 and as described above, in this exemplary embodiment, the supplying device 70 is provided with an inlet 79A that receives the developer from the developer container 80. The supplying device 70 is also provided with the outlet 74 used for discharging the developer.

The openings 505 provided in the protrusion 76 are provided above the inlet 79A. Moreover, the openings 505 are provided above the outlet 74 provided below the inlet 79A.

Furthermore, the openings 505 are provided in an area located away from the developer flow path 510.

In this exemplary embodiment, the developer flow path 510 is provided within the developer accumulation section 500. Moreover, the developer flow path 510 is also provided in the filling portion 511 (not illustrated in FIG. 14) as well as downstream of the filling portion 511.

The openings 505 are provided in an area located away from the developer flow path 510.

Moreover, the openings 505 are provided above an uppermost-located portion of the developer flow path 510.

In this exemplary embodiment, the area provided with the one-direction flow path 541 and the opposite-direction flow path 542 within the developer accumulation section 500, the developer flow path 510 extending through the filling portion 511, and the horizontal flow path 513 (not illustrated in FIG. 14) is the uppermost-located portion of the developer flow path 510.

The openings 505 are located above this uppermost-located portion.

The openings 505 provided in the protrusion 76 are the openings 505 that allow the inside and the outside of the supplying device 70 to communicate with each other.

In addition to the inlet 79A and the outlet 74, the supplying device 70 is provided with the openings 505 that allow the inside and the outside of the supplying device 70 to communicate with each other.

The gas flowing from the developing device 14 is discharged outward from the supplying device 70 via the openings 505.

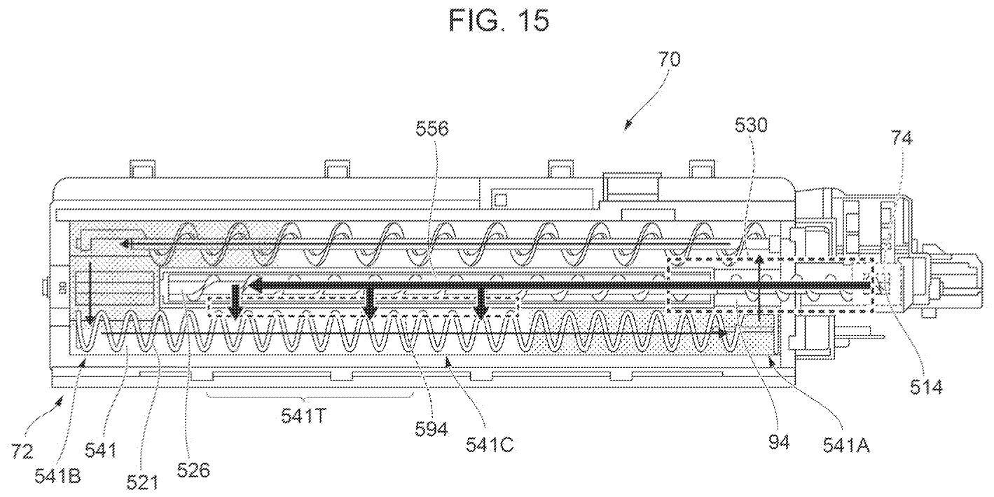

FIG. 15 illustrates the flow of the gas when the supplying device 70 is viewed from above. In FIG. 15, the upper member 561 and so on are omitted.

The gas flowing from the developing device 14 enters the supplying device 70 via the outlet 74 provided in the supplying device 70. The gas entering the supplying device 70 travels along the vertical flow path 514 and subsequently enters the gas flow path 530.

Then, the gas travels toward the interior wall space 556 via the gas flow path 530. The gas then travels toward the second end 72 of the supplying device 70 via the interior wall space 556.

Since the developer is not transported in the interior wall space 556, the amount of developer therein is small.

Subsequently, the gas travels toward the one-direction flow path 541 from the interior wall space 556. More specifically, the gas travels toward an area other than the first end 541A of the one-direction flow path 541.

The gas traveling from the interior wall space 556 toward the one-direction flow path 541 travels toward an area in the one-direction flow path 541 located upstream of the first end 521A. The term “upstream” refers to an upstream side of the one-direction flow path 541 in the developer movement direction.

As illustrated in FIG. 12, in this exemplary embodiment, the lower surface of the upper member 561 is provided with the recess 561C. As illustrated in FIG. 15, in this exemplary embodiment, the area where the recess 561C is provided is provided with a connection flow path 594 serving as a flow path that connects the interior wall space 556 and the one-direction flow path 541 to each other.

As illustrated in FIG. 15, the connection flow path 594 is connected to a central portion 541C of the one-direction flow path 541 in the longitudinal direction.

Furthermore, as illustrated in FIG. 15, the connection flow path 594 is also connected to a second end portion 541T serving as a portion of the one-direction flow path 541 located toward the second end 541B relative to the central portion 541C.

Therefore, in this exemplary embodiment, when the gas traveling through the interior wall space 556 travels toward the one-direction flow path 541, the gas travels toward the central portion 541C of the one-direction flow path 541 in the longitudinal direction and the second end portion 541T of the one-direction flow path 541, as illustrated in FIG. 15.

Subsequently, the gas travels toward the openings 505 provided in the protrusion 76 via the space inside the protrusion 76 (see FIG. 14).

The developer transported by the one-direction transport member 521 accumulates at the first end 541A of the one-direction flow path 541 (see FIG. 15). At the first end 541A, the upper surface of the developer increases in height.

In this case, when the gas in the interior wall space 556 travels above the first end 541A to travel toward the openings 505, it is difficult for the gas to pass thereabove.

In contrast, in this exemplary embodiment, the gas passes above the central portion 541C of the one-direction flow path 541 in the longitudinal direction, as well as above the second end portion 541T of the one-direction flow path 541. In this case, the gas passes an area where the height of the upper surface of the developer is low, thereby facilitating the flow of the gas.

The center transport member 526 is also provided in the interior wall space 556.

The center transport member 526 serving as an example of a movement member causes the developer accumulating in the interior wall space 556 to move.

In this exemplary embodiment, the gas from the gas flow path 530 is supplied into the interior wall space 556, and the developer contained in the gas accumulates in the interior wall space 556.

In this exemplary embodiment, the center transport member 526 that causes the developer accumulating in the interior wall space 556 to move is provided in the interior wall space 556.

The developer accumulating in the interior wall space 556 is transported toward the pre-filling space 94 by the center transport member 526. In this case, the developer in the interior wall space 556 is discharged from the interior wall space 556.

The center transport member 526 will now be described with reference to FIG. 9B.

The center transport member 526 is provided with a tubular inner portion 526E located within the tubular portion 512 and an outer portion 526F that is located downstream of the tubular inner portion 526E in the developer transport direction and that is located outside the tubular portion 512. The outer portion 526F is located within the horizontal flow path 513 serving as a part of the developer flow path 510.

In this exemplary embodiment, the developer transport capacity by the outer portion 526F is greater than the developer transport capacity by the tubular inner portion 526E.

In this exemplary embodiment, the outer diameter of the protrusion 526B provided at the outer portion 526F is larger than the outer diameter of the protrusion 526B provided at the tubular inner portion 526E.

Furthermore, in this exemplary embodiment, the pitch of the protrusion 526B provided at the outer portion 526F is larger than the pitch of the protrusion 526B provided at the tubular inner portion 526E.

In this description, the term “pitch” refers to the distance between adjacent segments of the protrusion 526B.

In this exemplary embodiment, the developer transport rate in the horizontal flow path 513 is higher than the developer transport rate in the tubular portion 512.

In this case, the height of the upper surface of the developer located in the horizontal flow path 513 is lower than the height of the upper surface of the developer located in the tubular portion 512.

When the height of the upper surface of the developer located in the horizontal flow path 513 is lower than the height of the upper surface of the developer located in the tubular portion 512, the height of the upper surface of the developer located below the gas flow path 530 decreases, as compared with a case where the height of the upper surface of the developer located in the horizontal flow path 513 is not lower than the height of the upper surface of the developer located in the tubular portion 512.

In this case, the developer located below the gas flow path 530 is less likely to enter the gas flow path 530, and the cross-sectional area of the gas flow path 530 increases.

Moreover, when the height of the upper surface of the developer located in the horizontal flow path 513 is lower than the height of the upper surface of the developer located in the tubular portion 512, the gas may flow readily along the vertical flow path 514, as compared with a case where the height of the upper surface of the developer located in the horizontal flow path 513 is not lower than the height of the upper surface of the developer located in the tubular portion 512.

When the height of the upper surface of the developer located in the horizontal flow path 513 is lower than the height of the upper surface of the developer located in the tubular portion 512, the area occupied by the developer in the cross section of the vertical flow path 514 decreases, as compared with a case where the height of the upper surface of the developer located in the horizontal flow path 513 is not lower than the height of the upper surface of the developer located in the tubular portion 512.

In this case, the gas traveling upward along the vertical flow path 514 may flow readily.

The structure surrounding the gas flow path 530 will be further described with reference to FIG. 9B.

In this exemplary embodiment, an upstream end 530C of the gas flow path 530 is located upstream of a downstream end 514C of the vertical flow path 514 in the gas movement direction in the gas flow path 530.

At the right end in FIG. 9B, the gas flow path 530 has the upstream end 530C serving as an upstream-most end in the gas movement direction in the gas flow path 530.

The vertical flow path 514 has an upstream end 514D and the downstream end 514C located at different positions from each other in the gas movement direction in the gas flow path 530.

The upstream end 514D and the downstream end 514C of the vertical flow path 514 are located at different positions from each other in the radial direction of the vertical flow path 514.

In this exemplary embodiment, when the positions in the gas movement direction in the gas flow path 530 are compared, the upstream end 530C of the gas flow path 530 is located upstream of the downstream end 514C of the vertical flow path 514. In FIG. 9B, the gas movement direction in the gas flow path 530 extends from right to left in FIG. 9B.

When the upstream end 530C is located upstream of the downstream end 514C, the gas may flow readily, as compared with a case where the upstream end 530C is located downstream of the downstream end 514C.

For example, it is assumed that the upstream end 530C of the gas flow path 530 is located at a position indicated by reference sign 9X, and that the upstream end 530C is located downstream of the downstream end 514C of the vertical flow path 514.

In this case, the flow path along which the gas flows becomes narrower, thus making it difficult for the gas to flow.

In contrast, when the upstream end 530C of the gas flow path 530 is located upstream of the downstream end 514C of the vertical flow path 514, as described above, the flow path along which the gas flows becomes wider, thus making it easier for the gas to flow.

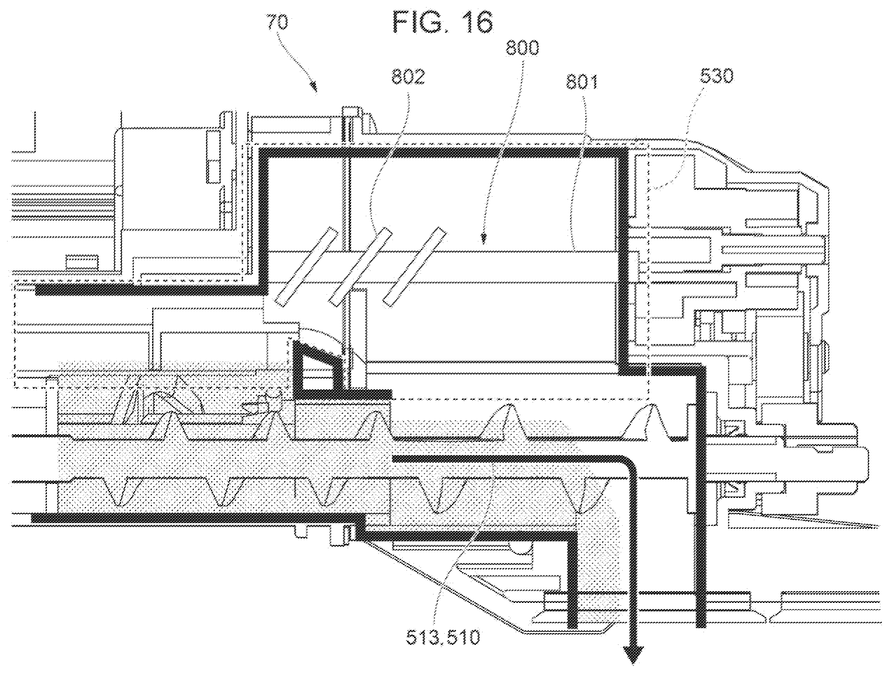

FIG. 16 illustrates another configuration example of the supplying device 70.

In the configuration example illustrated in FIG. 16, the gas flow path 530 is provided with a movement member 800 that causes the developer accumulating in the gas flow path 530 to move.

The movement member 800 includes a rotation shaft 801 that is rotated by a driving source (not illustrated), such as a motor, and a helical protrusion 802 protruding from the outer peripheral surface of the rotation shaft 801.

Gas traveling along the gas flow path 530 contains a developer, and the developer accumulates in the gas flow path 530.

In the configuration example illustrated in FIG. 16, the movement member 800 rotates to cause the developer to move rightward. The developer moved rightward by the movement member 800 falls downward so as to be supplied to the horizontal flow path 513 located therebelow.

The configuration of the first end 500A of the developer accumulation section 500 will be further described with reference to FIG. 11 again.

As illustrated in FIG. 11, in this exemplary embodiment, a regulator 95 is provided above the first end 541A of the one-direction flow path 541 to regulate upward movement of the developer in the one-direction flow path 541. The regulator 95 is constituted of a tabular member.

The developer accumulates at the first end 541A of the one-direction flow path 541, so that the upper surface of the developer increases in height at the first end 541A and the pre-filling space 94 accordingly.

In this case, the developer enters the gas flow path 530 located above the pre-filling space 94, possibly making it difficult for the gas to flow in the gas flow path 530.

In contrast, with the regulator 95 provided, the upper surface of the developer in the pre-filling space 94 is less likely to move upward. In this case, the entry of the developer into the gas flow path 530 may be suppressed, thus facilitating the flow of the gas along the gas flow path 530.

In addition to being provided above the first end 541A of the one-direction flow path 541, the regulator 95 may be provided above the pre-filling space 94. In this case, the gas flow path 530 is provided above the regulator 95.

### Second Exemplary Embodiment

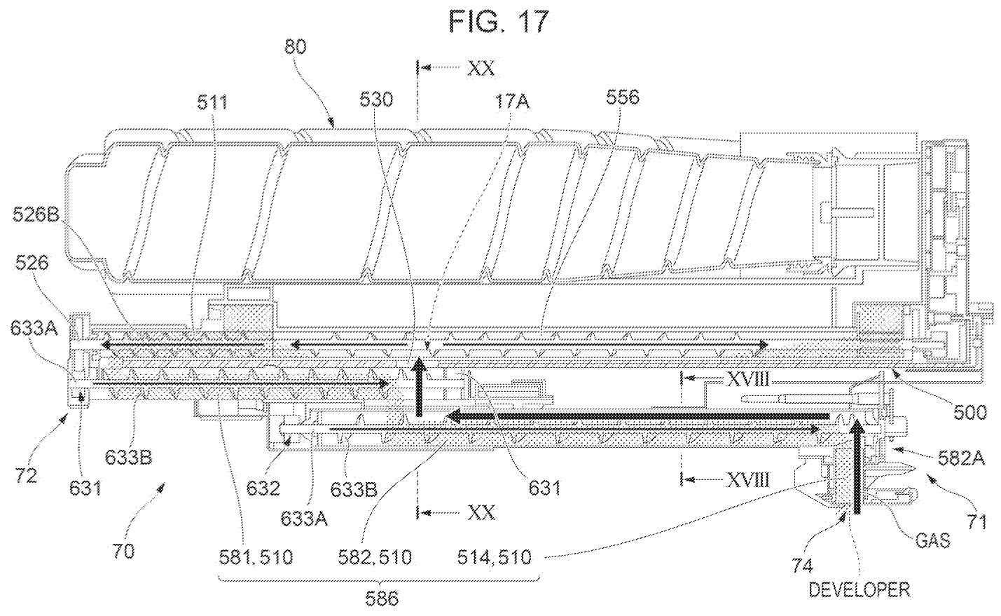

FIG. 17 illustrates the supplying device 70 according to a second exemplary embodiment.

The following description focuses on the differences from the first exemplary embodiment illustrated in FIGS. 7 to 16.

In the supplying device 70 illustrated in FIG. 17, the filling portion 511 is located toward the second end 72 of the supplying device 70. In other words, the filling portion 511 is located toward the front side of the image forming apparatus 100.

Furthermore, in the supplying device 70, an intermediate flow path 581 serving as a part of the developer flow path 510 is provided below the developer accumulation section 500, and a lower flow path 582 serving as another part of the developer flow path 510 is provided below the intermediate flow path 581.

The intermediate flow path 581 is provided therein with an intermediate transport member 631 that transports the developer in the intermediate flow path 581. The lower flow path 582 is provided therein with a lower transport member 632 that transports the developer in the lower flow path 582.

Each of the intermediate transport member 631 and the lower transport member 632 includes a rotation shaft 633A and a helical protrusion 633B protruding from the outer peripheral surface of the rotation shaft 633A.

Moreover, the supplying device 70 is provided with a driving source (not illustrated) for rotationally driving the intermediate transport member 631 and the lower transport member 632.

In the second exemplary embodiment, the developer that has passed through the filling portion 511 travels along the intermediate flow path 581 located below the developer accumulation section 500 and moves toward the lower flow path 582 located below the intermediate flow path 581.

Then, the developer travels toward a first end 582A of the lower flow path 582 via the lower flow path 582.

Subsequently, the developer travels toward the outlet 74 via the vertical flow path 514 extending downward from the first end 582A of the lower flow path 582.

In the second exemplary embodiment, the gas flow path 530 is provided in an area indicated by reference sign 17A.

Similar to the above, the gas flow path 530 branches off from the developer flow path 510.

In detail, the gas flow path 530 branches off from the intermediate flow path 581. The gas flow path 530 extends from a branch section branching off from the intermediate flow path 581 toward the developer accumulation section 500 located thereabove.

In the second exemplary embodiment, the gas flow path 530 extends in the vertical direction. The gas flow path 530 is provided with a vertically-extending portion.

In the second exemplary embodiment, the gas entering the supplying device 70 from the outlet 74 of the supplying device 70 travels upstream in the developer movement direction via a downstream portion 586 of the developer flow path 510.

In this case, the “downstream portion 586” refers to a portion of the developer flow path 510 located downstream of the filling portion 511 in the movement direction of the developer moving along the developer flow path 510.

In the second exemplary embodiment, the downstream portion 586 includes the intermediate flow path 581, the lower flow path 582, and the vertical flow path 514.

The gas entering the supplying device 70 from the outlet 74 of the supplying device 70 travels upstream in the developer movement direction via the downstream portion 586.

Subsequently, the gas enters the gas flow path 530 branching off from the downstream portion 586, and travels upward.

More specifically, the gas enters the gas flow path 530 branching off from the intermediate flow path 581 serving as a part of the downstream portion 586, and travels upward.

Then, the gas enters the interior wall space 556 provided in the developer accumulation section 500.

In the second exemplary embodiment, the developer transport capacity in the downstream portion 586 is greater than the developer transport capacity in the filling portion 511.

In detail, in the second exemplary embodiment, the developer transport capacity by the intermediate transport member 631 and the lower transport member 632 is greater than the developer transport capacity by the center transport member 526 extending through the filling portion 511.

In the second exemplary embodiment, the outer diameter of the protrusion 633B provided at each of the intermediate transport member 631 and the lower transport member 632 is larger than the outer diameter of the protrusion 526B provided at the portion of the center transport member 526 located within the filling portion 511.

Furthermore, in the second exemplary embodiment, the pitch of the protrusion 633B provided at each of the intermediate transport member 631 and the lower transport member 632 is larger than the pitch of the protrusion 526B provided at the portion of the center transport member 526 located within the filling portion 511.

In the second exemplary embodiment, the movement rate of the developer moving through the downstream portion 586 is higher than the transport rate of the developer moving through the filling portion 511.

In other words, in the second exemplary embodiment, the movement rate of the developer moving along the intermediate flow path 581 and the lower flow path 582 is higher than the transport rate of the developer moving through the filling portion 511.

Accordingly, in the second exemplary embodiment, the upper surface of the developer decreases in height in the downstream portion 586. This facilitates the flow of the gas traveling upstream via the downstream portion 586. In the cross section of the downstream portion 586, the developer does not entirely fill the cross section.

Furthermore, in the second exemplary embodiment, the developer transport capacity by the lower transport member 632 is greater than the developer transport capacity by the intermediate transport member 631.

More specifically, in the second exemplary embodiment, the outer diameter of the protrusion 633B provided at the lower transport member 632 is larger than the outer diameter of the protrusion 633B provided at the intermediate transport member 631.

Moreover, in the second exemplary embodiment, the pitch of the protrusion 633B provided at the lower transport member 632 is larger than the pitch of the protrusion 633B provided at the intermediate transport member 631.

In this case, the movement rate of the developer moving along the lower flow path 582 is higher than the transport rate of the developer moving along the intermediate flow path 581. In this case, the upper surface of the developer further decreases in height in the lower flow path 582. This further facilitates the flow of the gas traveling upstream along the lower flow path 582.

In the second exemplary embodiment, the movement rate of the developer moving along the lower flow path 582 is higher than the movement rate of the developer moving along the intermediate flow path 581, and the movement rate of the developer moving along the intermediate flow path 581 is higher than the movement rate of the developer moving through the filling portion 511.

In addition, the rotation speed of each of the intermediate transport member 631 and the lower transport member 632 may be higher than the rotation speed of the center transport member 526.

Moreover, the rotation speed of the lower transport member 632 may be higher than the rotation speed of the intermediate transport member 631.

Furthermore, the rotation speed of the lower transport member 632 may be higher than the rotation speed of the intermediate transport member 631, and the rotation speed of the intermediate transport member 631 may be higher than the rotation speed of the center transport member 526.

In this exemplary embodiment, the gas entering the supplying device 70 travels upstream in the developer movement direction via the developer flow path 510, and subsequently enters the gas flow path 530 branching off from the developer flow path 510.

More specifically, the gas entering the supplying device 70 travels upstream in the developer movement direction via the downstream portion 586 of the developer flow path 510. Then, the gas enters the gas flow path 530 branching off from the downstream portion 586.

Subsequently, the gas travels toward the openings 505 (not illustrated in FIG. 17) provided in the supplying device 70 via the interior wall space 556.

Although not described above, in the first exemplary embodiment illustrated in FIG. 9B, the gas entering the supplying device 70 from the outlet 74 of the supplying device 70 travels upstream in the developer movement direction via the downstream portion 586 of the developer flow path 510.

In the first exemplary embodiment illustrated in FIG. 9B, the downstream portion 586 includes the horizontal flow path 513 and the vertical flow path 514.

In the first exemplary embodiment illustrated in FIG. 9B, the gas entering the supplying device 70 from the outlet 74 of the supplying device 70 travels upstream in the developer movement direction via the downstream portion 586.

Then, the gas enters the gas flow path 530 branching off from the downstream portion 586, and moves leftward.

Subsequently, as described above, the gas travels toward the openings 505 via the interior wall space 556 (not illustrated in FIG. 9B), the one-direction flow path 541, and the space within the protrusion 76.

In the first exemplary embodiment illustrated in FIG. 9B, the developer transport capacity by the portion of the center transport member 526 located in the downstream portion 586 is greater than the developer transport capacity by the portion of the center transport member 526 located in the filling portion 511.

In other words, in the first exemplary embodiment illustrated in FIG. 9B, the developer movement rate in the downstream portion 586 is higher than the developer movement rate in the filling portion 511.

In this case, the upper surface of the developer decreases in height in the horizontal flow path 513 serving as a part of the downstream portion 586. In this case, the gas flow path 530 located above the horizontal flow path 513 increases in cross-sectional area.

In the cross section of the horizontal flow path 513 serving as a part of the downstream portion 586, the developer does not entirely fill the cross section.

When the developer movement rate in the downstream portion 586 is higher than the developer movement rate in the filling portion 511, the area of the developer occupying the cross section of the vertical flow path 514 decreases in the vertical flow path 514 serving as another part of the downstream portion 586. In this case, the gas may flow readily along the vertical flow path 514.

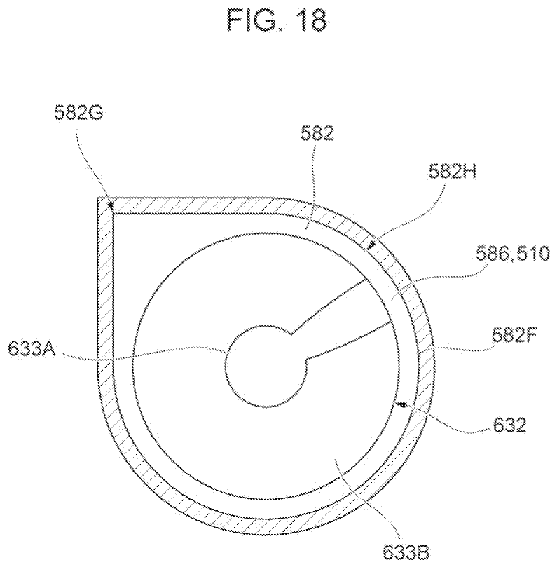

FIG. 18 is a cross-sectional view of the lower flow path 582, taken along line XVIII-XVIII in FIG. 17. In other words, FIG. 18 is a cross-sectional view of the downstream portion 586 of the developer flow path 510.

As illustrated in FIG. 18, the lower flow path 582 is provided with the lower transport member 632 serving as an example of a movement member. The lower transport member 632 rotates about the rotation shaft 633A extending along the lower flow path 582, so as to move the developer in the lower flow path 582 downstream.

As illustrated in FIG. 18, in this exemplary embodiment, the lower flow path 582 has a noncircular cross-sectional shape.

As illustrated in FIG. 17, the lower flow path 582 extends horizontally. In other words, the lower flow path 582 extends in the horizontal direction.

As illustrated in FIG. 18, in the cross section of the lower flow path 582 extending horizontally, an upper left portion 582G located at the upper left side in FIG. 18 of an outer peripheral edge 582F of the lower flow path 582 is a protrusion extending away from the rotation shaft 633A of the lower transport member 632.

With such a protrusion provided, the flow path of the gas may be readily ensured, as compared with a case where such a protrusion is not provided, thereby facilitating the movement of the gas along the lower flow path 582.

As an alternative to the upper left portion 582G located at the upper left side of the outer peripheral edge 582F of the lower flow path 582, an upper right portion 582H located at the upper right side may be a protrusion extending away from the rotation shaft 633A.

In addition, both the upper left portion 582G and the upper right portion 582H may be protrusions extending away from the rotation shaft 633A of the lower transport member 632.

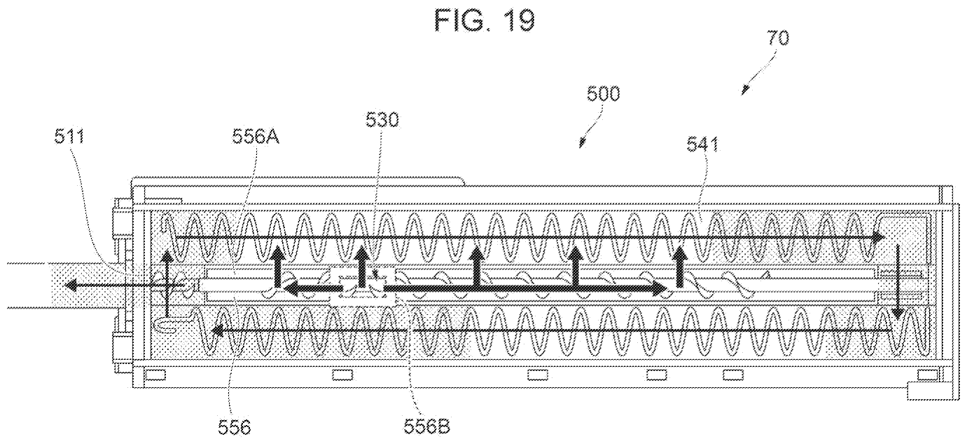

FIG. 19 illustrates the developer accumulation section 500 according to the second exemplary embodiment, as viewed from above.

In the second exemplary embodiment, the gas flow path 530 is connected to a base 556A of the interior wall space 556. The base 556A is provided with an opening 556B for connecting the interior wall space 556 and the gas flow path 530 to each other.

The gas from the gas flow path 530 is supplied into the interior wall space 556 from the base 556A of the interior wall space 556.

Subsequently, similar to the above, the gas entering the interior wall space 556 travels above the one-direction flow path 541 to move toward the space inside the protrusion 76 (not illustrated in FIG. 19).

Then, similar to the above, the gas travels through the space and is subsequently discharged outward from the supplying device 70 via the openings 505 provided in the lateral side of the protrusion 76.

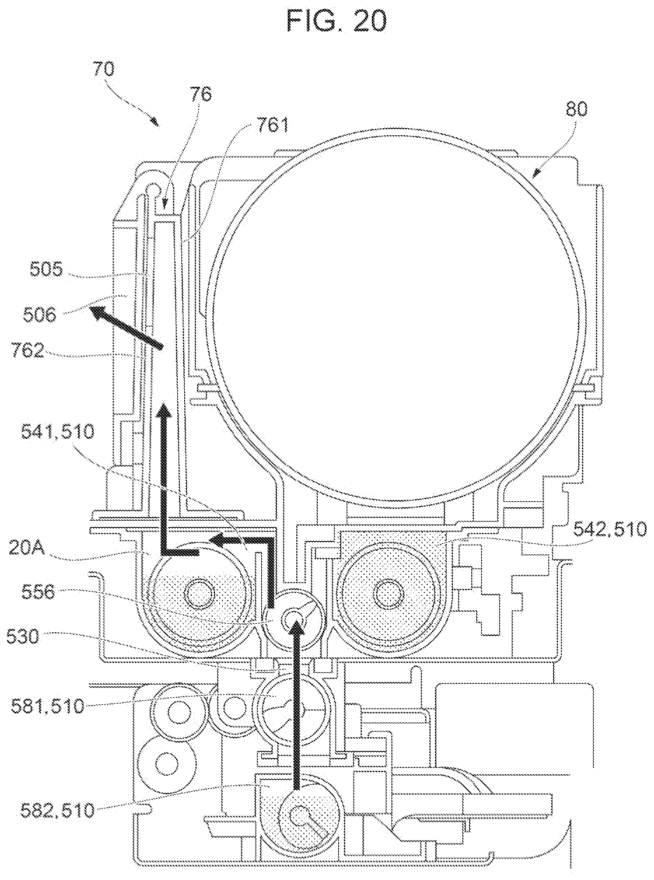

FIG. 20 is a cross-sectional view of the supplying device 70, taken along line XX-XX in FIG. 17. FIG. 20 illustrates the supplying device 70, as viewed from the first end 71 (see FIG. 17) of the supplying device 70.

As illustrated in FIG. 20, in the second exemplary embodiment, the developer flow path 510 along which the developer from the developer container 80 travels is similarly provided below the developer container 80.

In the second exemplary embodiment, a part of the developer flow path 510 is located away from a position directly below the developer container 80. In detail, of the one-direction flow path 541, a part indicated by reference sign 20A is located away from the position directly below the developer container 80.

In this configuration example, the protrusion 76 extending upward is provided above the one-direction flow path 541 partially located away from the position directly below the developer container 80.

Similar to the first exemplary embodiment illustrated in FIGS. 7 to 16, the space inside the protrusion 76 according to the second exemplary embodiment is connected to the one-direction flow path 541.

In the second exemplary embodiment, the protrusion 76 extending upward is provided above the part of the developer flow path 510 located away from the position directly below the developer container 80.

In this exemplary embodiment, this part is a part of the one-direction flow path 541 located away from the position directly below the developer container 80.

Similar to the above, the protrusion 76 has an internal cavity, such that the protrusion 76 has a space therein for allowing the gas to travel therethrough.

The gas reaching above the one-direction flow path 541 via the gas flow path 530 and the interior wall space 556 travels through the space inside the protrusion 76, and moves toward the openings 505 provided in the lateral side of the protrusion 76. Then, the gas is discharged outward from the supplying device 70 via the openings 505.

Similar to the above, of the surfaces that the protrusion 76 has, the opposite surface 762 opposite the facing surface 761 that faces the developer container 80 is provided with the openings 505 provided in the protrusion 76.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) An image forming apparatus comprising:
an image bearing member;
a developing device that causes a developer to adhere onto the image bearing member; and
a supplying device that supplies the developer to the developing device, the supplying device including an inlet that receives the developer from upstream, an outlet used for discharging the received developer, and an opening that is provided separately from the inlet and the outlet and that allows an inside and an outside of the supplying device to communicate with each other.

(((2))) The image forming apparatus according to (((1))),
wherein the opening is provided above the inlet.

(((3))) The image forming apparatus according to (((2))),
wherein the outlet is provided below the inlet, and
wherein the opening is provided above the inlet and the outlet.

(((4))) The image forming apparatus according to any one of (((1))) to (((3))),
wherein the supplying device is provided with a developer flow path along which the developer travels, and
wherein the opening is provided at a position located away from the developer flow path.

(((5))) The image forming apparatus according to (((4))),
wherein the opening is provided above an uppermost-located portion of the developer flow path.

(((6))) The image forming apparatus according to any one of (((1))) to (((5))),
wherein the supplying device is provided with a protrusion that extends upward and that has an internal cavity, and
wherein the protrusion is provided with the opening.

(((7))) The image forming apparatus according to (((6))),
wherein the supplying device transports the developer from a developer container and supplies the developer to the developing device,
wherein the supplying device is provided with a developer flow path that is located below the developer container and along which the developer from the developer container travels,
wherein a part of the developer flow path is located away from a position directly below the developer container, and
wherein the protrusion extending upward and having the internal cavity is provided above the part of the developer flow path, the part being located away from the position directly below the developer container.

(((8))) The image forming apparatus according to (((7))),
wherein a part of the protrusion extending upward is located alongside the developer container, and
wherein, of surfaces that the protrusion has, an opposite surface opposite a facing surface facing the developer container is provided with the opening.

(((9))) The image forming apparatus according to any one of (((1))) to (((8))),
wherein the supplying device is provided with a gas flow path along which gas flowing from the developing device to the supplying device and moving toward the opening travels, the gas flow path being provided separately from a developer flow path along which the developer moving toward the developing device travels.

(((10))) The image forming apparatus according to any one of (((1))) to (((9))),
wherein the developing device is provided with a facing opening that is disposed at a position facing the image bearing member and where a rotating member used for supplying the developer to the image bearing member is disposed, and an inlet opening that receives the developer, and
wherein, other than the facing opening and the inlet opening, the developing device is not provided with an opening that allows an inside and an outside of the developing device to communicate with each other.

(((11))) An image forming apparatus comprising:
an image bearing member;
a developing device that causes a developer to adhere onto the image bearing member; and
a supplying device that supplies the developer to the developing device, the supplying device including an opening that is used for discharging gas flowing from the developing device.

(((12))) The image forming apparatus according to (((11))),
wherein the developing device is provided with a facing opening that is disposed at a position facing the image bearing member and where a rotating member used for supplying the developer to the image bearing member is disposed, and an inlet opening that receives the developer, and
wherein, other than the facing opening and the inlet opening, the developing device is not provided with an opening that allows an inside and an outside of the developing device to communicate with each other.

What is claimed is:

1. An image forming apparatus comprising:
an image bearing member;
a developing device that causes a developer to adhere onto the image bearing member; and
a supplying device that supplies the developer to the developing device, the supplying device including an inlet that receives the developer from upstream, an outlet used for discharging the received developer, and an opening that is provided separately from the inlet and the outlet and that allows an inside and an outside of the supplying device to communicate with each other.

2. The image forming apparatus according to claim 1,
wherein the opening is provided above the inlet.

3. The image forming apparatus according to claim 2,
wherein the outlet is provided below the inlet, and
wherein the opening is provided above the inlet and the outlet.

4. The image forming apparatus according to claim 1,
wherein the supplying device is provided with a developer flow path along which the developer travels, and
wherein the opening is provided at a position located away from the developer flow path.

5. The image forming apparatus according to claim 4,
wherein the opening is provided above an uppermost-located portion of the developer flow path.

6. The image forming apparatus according to claim 1,
wherein the supplying device is provided with a protrusion that extends upward and that has an internal cavity, and
wherein the protrusion is provided with the opening.

7. The image forming apparatus according to claim 6,
wherein the supplying device transports the developer from a developer container and supplies the developer to the developing device,
wherein the supplying device is provided with a developer flow path that is located below the developer container and along which the developer from the developer container travels,
wherein a part of the developer flow path is located away from a position directly below the developer container, and
wherein the protrusion extending upward and having the internal cavity is provided above the part of the developer flow path, the part being located away from the position directly below the developer container.

8. The image forming apparatus according to claim 7,
wherein a part of the protrusion extending upward is located alongside the developer container, and
wherein, of surfaces that the protrusion has, an opposite surface opposite a facing surface facing the developer container is provided with the opening.

9. The image forming apparatus according to claim 1,
wherein the supplying device is provided with a gas flow path along which gas flowing from the developing device to the supplying device and moving toward the opening travels, the gas flow path being provided separately from a developer flow path along which the developer moving toward the developing device travels.

10. The image forming apparatus according to claim 1,
wherein the developing device is provided with a facing opening that is disposed at a position facing the image bearing member and where a rotating member used for supplying the developer to the image bearing member is disposed, and an inlet opening that receives the developer, and
wherein, other than the facing opening and the inlet opening, the developing device is not provided with an opening that allows an inside and an outside of the developing device to communicate with each other.

11. An image forming apparatus comprising:
an image bearing member;
a developing device that causes a developer to adhere onto the image bearing member; and
a supplying device that supplies the developer to the developing device, the supplying device including an opening that is used for discharging gas flowing from the developing device.

12. The image forming apparatus according to claim 11,
wherein the developing device is provided with a facing opening that is disposed at a position facing the image bearing member and where a rotating member used for supplying the developer to the image bearing member is disposed, and an inlet opening that receives the developer, and
wherein, other than the facing opening and the inlet opening, the developing device is not provided with an opening that allows an inside and an outside of the developing device to communicate with each other.

13. An image forming apparatus comprising:
image bearing means;
developing means for causing a developer to adhere onto the image bearing means; and
supplying means for suppling the developer to the developing means, the supplying means including an inlet that receives the developer from upstream, an outlet used for discharging the received developer, and an opening that is provided separately from the inlet and the outlet and that allows an inside and an outside of the supplying means to communicate with each other.
